(19) United States
(12) Patent Application Publication
(10) Pub. No.: US 2015/0230524 A1
(43) Pub. Date: Aug. 20, 2015

(54) Thermal-Regulated Apparel and Wireless Control System Therefor

(71) Applicant: Gerbings, LLC., Stoneville, NC (US)

(72) Inventors: Kayla Stevens, Greensboro, NC (US); Cupid Roberts, Stoneville, NC (US); Spencer Bass, Stoneville, NC (US)

(21) Appl. No.: 14/657,769

(22) Filed: Mar. 13, 2015

Related U.S. Application Data
(63) Continuation-in-part of application No. 14/503,804, filed on Oct. 1, 2014.
Application No. 14/503,804 is a continuation-in-part of application No. 62/055,072, filed on Sep. 25, 2014.
(60) Provisional application No. 61/885,166, filed on Oct. 1, 2013.

(51) Int. Cl. A41D 13/005; H05B 1/02

(52) U.S. Cl. CPC A41D 13/0051; H05B 1/02; H05B 1/0272

(57) ABSTRACT

The present inventive concept relates to electrically-powered, thermal-regulated apparel or heated garments and a controller and related methods of operation thereof. The thermal-regulated apparel item includes a heating assembly having a heating element and a controller that is linked to the heating element. The controller receives measured temperature or other feedback such as electrical resistance values from a thermistor or a voltage level of a thermocouple positioned along the heating element and in response, varies an electrical power output to the heating element to maintain a desired thermal output. The controller also communicates with a user settable control device, which can include a wireless control device, such as a Smart phone, through which the user can monitor and control the thermal output of one or more heated garments linked thereto.

### CROSS-REFERENCE TO RELATED APPLICATIONS

The present Patent Application is a continuation-in-part of previously filed, co-pending U.S. patent application Ser. No. 14/503,804, filed Oct. 1, 2014, which is a formalization of previously-filed U.S. Provisional Patent Application Ser. No. 61/885,166, filed Oct. 1, 2013. The present Application further is a formalization of U.S. Provisional Application Ser. No. 62/055,072, filed Sep. 25, 2014. This Patent Application accordingly claims the benefit of the filing date of the above-cited United States Utility and Provisional Patent Applications according to the statutes and rules governing provisional patent applications, particularly 35 U.S.C. §119(a)(3), 119(a)(4) and 37 C.F.R. §1.78(a)-(c). The specification and drawings of the United States Provisional Patent Applications referenced above are specifically incorporated herein by reference as if set forth in their entirety.

### FIELD OF THE INVENTION

The present disclosure generally relates to heated or thermally-regulated apparel and to a control device, system, and related methods for thermal regulation in garments/apparel, including self-governing thermally regulated apparel and related articles. In particular, embodiments of the present disclosure relate to heated or thermally-regulated garments or apparel and a control system therefor, including a controller capable of detecting electrical resistance values, voltage levels, or similar data sets, and adjusting the thermal output of the garment to predetermined or desired levels that can be established and/or input by a user, including a system and application for enabling the user to wirelessly monitor and control such a garment or other heated article.

### BACKGROUND OF THE INVENTION

In the garment and apparel industry, manufacturers, designers, and engineers have attempted to address the issue of temperature regulation in heated or thermally-regulated apparel. Individuals residing in extreme weather environments may require apparel or garments or other similar articles designed and manufactured to address user comfort and survival in such environments. Likewise, individuals participating in certain work-related or recreational activities, such as skiing, hunting and fishing, motorcycle and ATV riding and other outdoor activities may also require apparel and garments designed and manufactured to address comfort and feasibility in engaging in such work or recreation. For example, soldiers and aircraft crew often must perform tasks or operations in extreme cold environments, and thus have a need for protective clothing that provides needed warmth and protection from hypothermia, without restricting movement and which can be expanded and be used in a variety of different environments. Additionally, such protective clothing also can be subjected to and thus must be protected from other potential problems/conditions, such as exposure to electrical surges or interference.

To that end, various devices and methods attempting to address the issue of apparel/garment temperature regulation have been developed, including U.S. Pat. No. 5,148,002; and U.S. Published Patent Application No. 2007/0199137. For example, clothing such as pants, shoes, helmets, etc., has been developed with heating pads or devices that are received or sewn therein, and which are powered by an electrical power source such as a battery, to provide both longer and/or more consistent applications of heat through the clothing. Such electrically heated garments have included rechargeable or replaceable power supplies, enabling longer heating times, and in some cases can provide the user with more control of the heat being applied by the various heating elements within a particular article of clothing. One problem that seems to exist, however, is that it is often difficult for the wearer to quickly, easily and accurately make adjustments to the temperature or heat being applied by the garment, if they are too hot or too cold, the wearer further typically must unzip or remove the garment to adjust the heating apparatus.

Known methods, devices, and systems generally measure ambient temperature of an end user as a reference point, then attempt to maintain or adjust heat production in response to environmental changes based on a previously recorded ambient temperature reading. Disadvantageously, this approach typically can require multiple monitoring points, expensive equipment capable of taking such temperature measurements within a narrow error range, and often a multitude of sensors and/or other components that can potentially lead to or create numerous failure points that can hinder overall function of the heated garment. The need for such additional temperature monitoring devices or components also can add to the overall expense, as well as the weight/bulk of a garment in which they are installed, and can otherwise affect the freedom of movement, fit and comfort of the garment.

Accordingly, a need exists for heated or thermally regulated garments, apparel or other, similar articles and a control system therefor that addresses the foregoing and other related and unrelated problems and challenges in the art.

### SUMMARY OF THE INVENTION

Briefly described, the present invention generally is directed to a heated garment or thermally regulated apparel item, or similar articles having one or more integratable heating element assemblies, and a heating control system, and related methods for self-governing operation/control of such thermally regulated apparel, which can be operated independent of recording, measuring, or otherwise determining an actual temperature value. Thus, no actual temperature value measurements are necessary for operation and achieving the desired self-governing control of the thermally regulated apparel and control system, and related methods of the present inventive concept. The thermally regulated article further can include integrated insulating or shielding materials for protection against electromagnetic or other electrical interference and/or to provide insulating or other protective properties to the heating element assemblies.

Objects of the present inventive concept include providing an electrically-powered heated or thermally regulated garment or one or more articles of apparel, clothing, equipment such as vehicle seats, textile articles such as blankets and cushions, and other, similar devices, and a heating control system therefor. In one embodiment, the control system will include a controller which can include user operable and/or settable controls. A first input or user control can be configured to establish an electrical power output from an electrical power source to an electrical power outlet connector. The electrical power output can continuously repeat at a predetermined amperage or voltage and also for a predetermined frequency and duration, depending on input from the user.

The controller also can include additional or second inputs or user controls. The second input or user control is capable of being engaged and disengaged by the user and can include a separate unit or part, which can be wirelessly linked to the controller. In one embodiment, the controller can be configured such that when initially engaged, a temperature measurement, which can include a measured temperature or other measured value such as, for example, electrical resistance values of a thermistor, or alternatively, a voltage level of a thermocouple, can be measured to help set a baseline for the user's personal temperature or thermal output preferences for the article. As such temperature, resistance value(s) and/or voltage level(s) are measured, as long as the second user control is engaged, the first user control can be overridden and the user can adjust the power supplied to correspondingly adjust the heating applied by the garment/apparent item. Once a heating level for a desired comfort level of the user/wearer is determined by the user, a corresponding electrical resistance value or voltage level, or desired ranges thereof, can be selected/set via the second input or user control, i.e., by the user activating the second input control or inputting a selected set point or range therefor.

Thereafter, the electrical power output to the heating element(s) of the garment/apparel item will be controlled/varied in response to feedback from the garment/apparel item such as via a sensor providing a measured temperature, electrical resistance value(s) of the thermistor, or the voltage level(s) of a thermocouple, remain relatively constant with respect to the initially set/predetermined temperature, resistance or voltage level values. In other words, the resistance value and/or voltage level can be substantially maintained within a predetermined range with respect to the initially determined/measured and set values therefor. When the second input or user control is disengaged or deactivated, the electrical power output likewise can be deactivated, or can return to a last electrical power output setting established by operation of the first input or user control.

In some embodiments, the controller also can include two or more electrical power outlet and/or outlet connectors, each operating independently from the other, two or more first input or user controls, each operating independently from the other, and two or more second input or user controls, which also can each operate independently from the other. The control of the garments or other heated devices or articles also can be done on a zone basis wherein a series of heating elements of a garment, or a series of connected garments, can be monitored independently and controlled on a zone-by-zone (e.g., chest, arms, hands, etc.) basis. In addition, the user controls of the controller further can include separable parts in wireless communication with each other, sometimes referred to as a transmitter and a receiver, although both components can comprise transceivers capable of both transmitting and receiving wireless signals.

For example, in other embodiments, the heating control system will comprise a wireless heating control system for enabling the wearer or user to quickly and efficiently control the application of heat to the heated garment or device, utilizing a wireless controller linked to the heating apparatus, such as by Bluetooth® or other wireless connectivity which can be integrated with or linked to the controller of the heating system. The heating system can be controlled by and communicate with a remote wireless controller such as a Smart Phone operating a heating system control application, to enable a user to remotely/wirelessly control the application of heat applied to the heated garment or article as needed to adjust or maintain the temperature of the heated garment or device.

A series of heating system control modules further can be provided, each of which can be linked to and/or configured for use with selected apparel items or other, similar heated devices, and further including a Bluetooth® or other wireless controller/connector that will communicate with a user's wireless device, such as their Smart Phone, through a wireless heating control system application. The Bluetooth® controller can be integrated into the heating apparatus control module and can be configured to draw power from the internal power supply, or can be integrated into the battery or power supply for the garment to enable addition of Bluetooth®/wireless control including to existing heated garments. Alternatively, the Bluetooth® controller can comprise a separate module that can be connectable to each heating system control module for each heated garment or device, and can draw power therefrom, or can be provided with its own power supply, as needed for some applications. The Bluetooth® controller further generally will be configured as a two-way Bluetooth® controller/connector that can communicate the identity of a particular heated garment or device to be controlled, as well as updates of a monitored or calculated temperature of the heated garment or device to the user's wireless control device, and through which the user will be enabled to wirelessly or remotely communicate instructions for regulating the temperature of the heated garment or device.

The wireless heating control system application running on the wireless control device also can include a series of display screens or pages through which the user can be provided with a visual indication of the monitored temperature of each heated garment or device being controlled, and can utilize the touch screen functionality of the Smart Phone to enable control/adjustments (i.e., the changing of the temperature of the monitored garment or device) via buttons, sliding tabs or scales, or other touch controls. In other embodiments, the wireless heating control system and wireless heating system control application could be configured to support multiple heating systems, for example, the control of up to four or more different heated garments, each using a corresponding two-way Bluetooth® connection. The Bluetooth® connector/controller for each such heated garment or device being controlled also can be configured to recognize and/or can be programmable so as to be linked or dedicated to a particular article or device, and thereafter can distinctly identify the particular article or device upon connection to the wireless heating control. Such wireless connections can be configured to be made automatically, with an indicator or alert being provided upon connection. Alternatively, in other embodiments, a series of heated devices could be linked together for control thereof as a collective set or unit, as well as on a zone-by-zone or similar basis.

The wireless heating system control application also can be provided with customizable control and/or display screens identifying and displaying the monitored temperature for each heated garment or device connected to the wireless control device, and other monitored parameters. The user can use the touch screen of their Smart Phone or other wireless device to make adjustments to the temperature of each heated garment or device separately, thus enabling them to regulate the temperature of each heated garment or device, or individual heating element assemblies thereof, being controlled as needed. The wireless heating control system also can provide for preset or optimum temperature values or ranges to be programmed, such as to conserve battery power and/or to avoid overheating.

Additional objects of the present inventive concept include providing an electrically-powered thermally regulated apparel system including a controller as discussed above, and wherein the thermally regulated apparel or heated garments can be connected individually or in series to one or more electrical power outlets of the controller. Electric power thus can be regulated and supplied to the apparel item or set of items from an electrical power source connected to a power input of the controller. The power source can be in integratable or replaceable battery pack or similar power supply, or an externally located power source, such as a vehicle battery. Each thermally regulated apparel item also can include one or more heating element assemblies applied or located along selected portions thereof, such as fitting into pockets, and with each heating element assembly generally being configured to provide a desired thermal coverage or application area.

Each heating element assembly generally can include a substrate or base layer, which can be formed from a flexible fabric material and over which a shielding material, such as a layer of an electro-magnetic or other electrical interference (EMI) shielding material, or insulating fabric will be applied. An electrical resistance heating element, which can comprise a conductive wire, thread, filament or fiber, generally will be applied between the base layer and the shielding or insulating layer. In one embodiment, the electrical resistance heating element can be applied to the base layer or substrate, such as by stitching or other means, in a desired pattern extending substantially along and across the substrate and with the ends thereof being connected to a plug-in connector. Alternatively, the electrical resistance heating element could be applied or attached to the EMI shielding layer, such as by stitching or sewing the electrical resistance heating element thereto, and then attaching the EMI shielding layer to the base layer or substrate. Additional shielding or insulating layers further can be applied thereover as needed.

The heating control system further generally can include control element or module, with a power supply, such as a rechargeable or replaceable battery, integrated into or connected to the control module for powering the heating elements connected thereto. Each of the heating elements generally will be connected to its associated or corresponding control module and power supply via conductive wires or leads that can be attached or integrated into the garment or device. Additional connective leads further can be provided for recharging the power supply and/or for connection to an external power source. One or more temperature sensors also can be provided, such as by being integrated into new garments or devices and/or connected to the control module, to provide monitored temperature readings to the control module.

For example, in some embodiments, one or more thermistors can be imbedded or installed at one or more desired locations along the heating element of each heating element assembly. The thermistor(s) will be linked to the controller for the thermally regulated apparel item via leads or other connections, or each can be connected to a secondary controller or module imbedded within their associated heating element assembly. The thermistor(s) will provide feedback to the controller of measured or monitored electrical resistance of the electrical resistance heating element. In response, the controller will regulate or control the electrical power provided to the electrical resistance heating element of each heating assembly as needed to maintain the monitored resistance within a desired or predetermined range to control the amount of heat applied by each heating assembly to its thermally regulated apparel item. Alternatively, one or more thermocouple(s) can be similarly imbedded within each heating assembly of the thermally regulated apparel item and will provide feedback to the controller as to voltage levels being supplied to each heating assembly.

The power source for the thermally regulated apparel system or item further can be detachably connected to the thermally regulated apparel item independent of the heating control system and can be removably incorporated into each apparel item, or, one or more items of a connected series or “suit”; or can comprise an electrical generator linked to the controller unit by a power inlet connector. In embodiments with multiple power outlet connectors, one connector can be attached to one apparel item and another connector connected to an additional apparel item, with each different apparel item being supplied power through the controller and regulated independently from the other.

Still further, the status of the battery or other internal power source of each heating apparatus or system also can be monitored and feedback sent to the controller, such as, through an incorporated or connected Bluetooth® communication module or functionality (i.e., the battery/power source can incorporate Bluetooth® connectivity), to a wireless control devices. i.e., the user's Smart Phone, to alert the user as to the level or amount of available battery power during use of the heated garment or device. The controller also can be configured to use other applications or features of a user's wireless device, such as retrieving the ambient temperature of the surrounding environment or weather updates through their Smart Phone, and functionality that enables the user to set a desired range or temperatures, including establishing a default temperature range for the heated garment or device if the surrounding environmental or ambient temperature is detected at a certain level or in a prescribed range, or if the detected power level or the heating apparatus power supply drops below a desired or preset level. Still further, the wireless heating control system can also be provided with other control screens and/or links to various websites, such as to retain and/or social media sets.

When the controller is activated by a user, an initial value or set/range of user temperature ranges/preferences can be recorded and/or selected by the user. Such initial values can be determined based on sensor feedback, such as initial temperature measure, or other measured value. For example, electrical resistance values of a thermistor or an initial voltage level value of a thermocouple can be recorded. The electrical resistance, voltage level, or other value can be arbitrary and further may have no direct correlation to an actual ambient temperature until set or correlated by user activation of the controller. Once such a measure or value is established and set, the controller unit thereafter will apply varying levels of power from the power source, to provide varying levels of thermal output to the self-governing apparel, thereby maintaining the measured level/value of a sensor (i.e., electrical resistance of a thermistor or voltage level of the thermocouple) within a predefined range with respect to the recorded value to thus maintain heating of the garment in accordance with the preferences of the user.

Often, thermistor based heating control appliances or designs will call for approximately 1% tolerance thermistors to be used. However, since there are numerous different response curves for different thermistors, the thermistor curve type also must be specified and taken into account, which can represent an additional barrier to designing apparel capable of thermal regulation. However, by utilizing a predetermined or arbitrary setpoint that is recorded when the controller unit is activated by a user, the control system on the circuitry thereof can be built using lower cost parts, or parts with a wider tolerance range. For example, instead of using expensive temperature sensors or alternatively more costly 1% precision thermistors, the control system, and related methods can be implemented using significantly lower cost thermistors, for example, approximately 10%-20% tolerance thermistors. Various alternative types of thermistors also can be used, and each thermistor used need not be identical to other thermistors, or necessarily maintain or use a known component value; this allows for substantial cost savings, as the difference between a 1% tolerance component versus a 10% tolerance component can be orders of magnitude in difference. The same can apply to the use of thermocouples.

The foregoing and other objects are intended to be illustrative of the general inventive concept and are not meant in a limiting sense. Many possible embodiments of the invention may be made and will be readily evident upon a study of the entire specification and accompanying drawings comprising a part thereof. Various features and subcombinations of the general inventive concept may be employed without reference to other features and subcombinations. Other objects and advantages of the general inventive concept will become apparent from the following description taken in connection with the accompanying drawings, wherein is set forth by way of illustration and example, embodiments of this invention and various features thereof.

### BRIEF DESCRIPTION OF THE DRAWINGS

The foregoing and/or other aspects and utilities of the present general inventive concept will become apparent and more readily appreciated from the following description of the embodiments, taken in conjunction with the accompanying drawings. For the purpose of illustration, forms of the present general inventive concept which are presently preferred are shown in the drawings; it being understood, however, that the general inventive concept is not limited to the precise arrangements and instrumentalities shown. In the drawings:

FIG. 1 illustrates one exemplary embodiment of a controller for a thermally-regulated apparel item according to the principles of the present invention.

FIGS. 2A-2B illustrates another exemplary embodiment of the controller for a thermally-regulated apparel item according to the principles of the present invention with the controller having multiple parts and/or multiple independent operating channels.

FIG. 3A illustrates one example embodiment of a heating system for a garment, shown as a jacket or shirt, incorporating heating elements or devices that can be controlled using the wireless heating control system according to the principles of the present invention.

FIG. 3B is a perspective illustration of a series of clothing articles which can be interconnected together and controlled via the heating control system according to the principles of the present invention.

FIG. 3C is a perspective view of another embodiment of a heating system for garments, shown as a boot with a liner or pad received therein.

FIGS. 4A-4B are perspective views of alternative heated devices that can be controlled using the heating control system according to the principles of the present invention.

FIGS. 5A-5C illustrate one example embodiment of a thermally-regulated apparel item in accordance with the principles of the present invention.

FIGS. 6A-6C illustrate one embodiment of a thermally-regulated apparel item with a shielding layer in accordance with the principles of the present invention.

FIGS. 7A-7D illustrate yet another embodiment of a thermally-regulated apparel item with a shielding layer in accordance with the principles of the present invention.

FIG. 8 illustrates one embodiment of a home screen for a wireless heating system control application for operation of the heating control system according to the principles of the present invention.

FIG. 9 illustrates another embodiment of an application control screen for the wireless heating control system, providing for feedback regarding available power levels for the heating apparatus being monitored.

FIGS. 10A-10D illustrate further example embodiments of various application control screens that can be incorporated into the wireless control device application of the wireless heating control system according to the principles of the present invention.

FIGS. 11A-11B illustrate additional embodiments of application screens displaying monitored temperature data, and which include links enabling the purchase of additional wireless heating control device applications and/or heated articles via an online store connection.

FIGS. 12A-12E illustrate further embodiments of various application control screens, including a temperature gauge or dial for operation of the heat control system and/or a heat lock icon or tab for activation of a heat lock function.

FIGS. 13A-13D illustrate additional examples of various application screens that can be incorporated into the wireless control device application of the wireless heating control system according to embodiments of the present invention.

FIGS. 14A-14B illustrate even further example embodiments of various application screens that can be incorporated into the wireless control device application of the wireless heating control system according to principles of the present invention.

FIGS. 15 illustrates yet another example embodiment of an application screen that can be incorporated into the wireless control device application of the wireless heating control system according to the principles of the present invention.

FIGS. 16A-16D illustrate embodiments of various application control screens, including a temperature gauge or dial for operation of the heat control system and/or a garment selection icon or tab.

FIGS. 17A-17D illustrate additional embodiments of various application control screens, including a temperature gauge or dial for operation of the heat control system and/or a garment selection icon or tab.

FIGS. 18A-18C illustrate even further embodiments of various application control screens, including a temperature gauge or dial for operation of the heat control system and/or a garment selection icon or tab.

Those skilled in the art will appreciate and understand that, according to common practice, the various features of the drawings discussed below are not necessarily drawn to scale, and that the dimensions of various features and elements of the drawings may be expanded or reduced to more clearly illustrate the embodiments of the present invention described herein.

### DETAILED DESCRIPTION

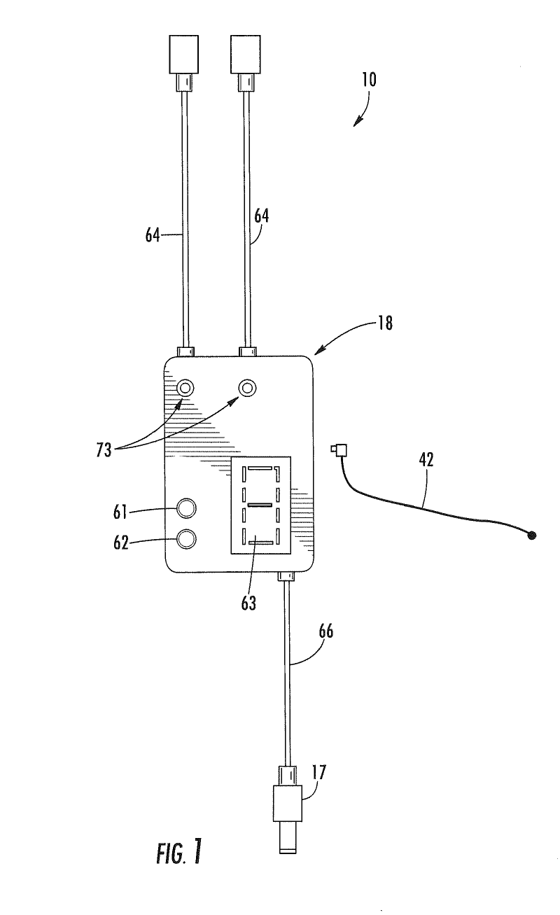

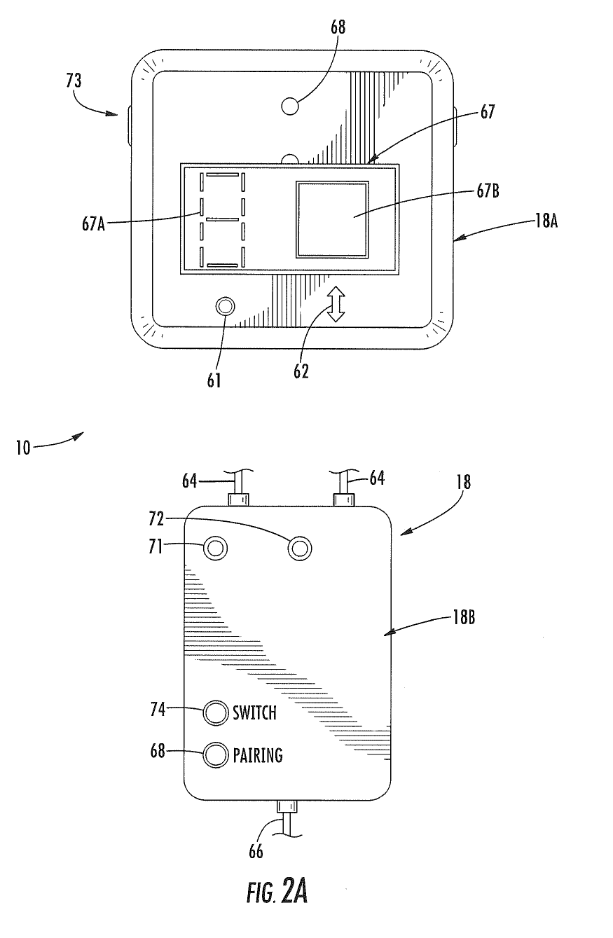

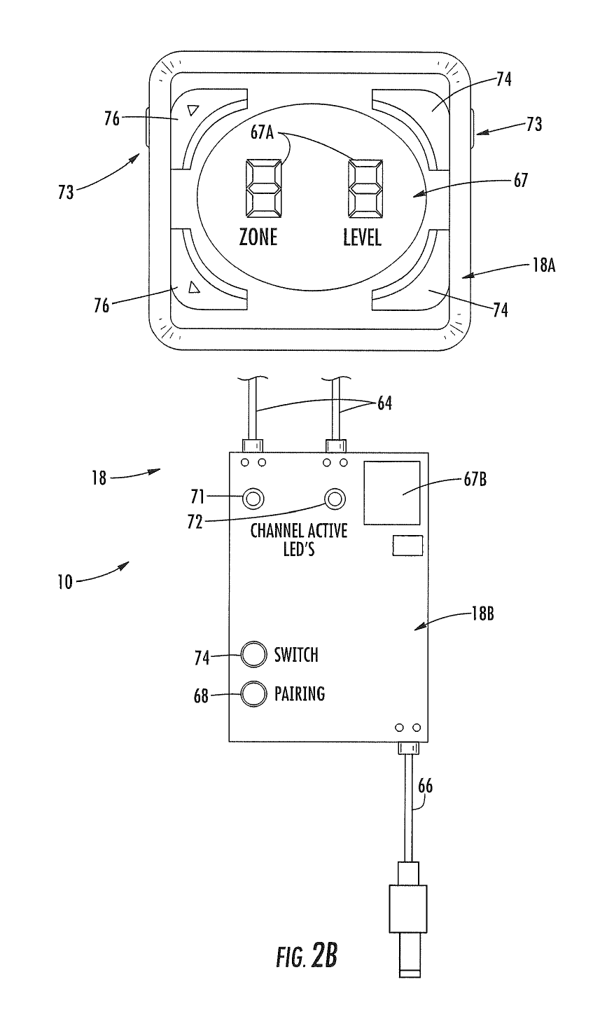

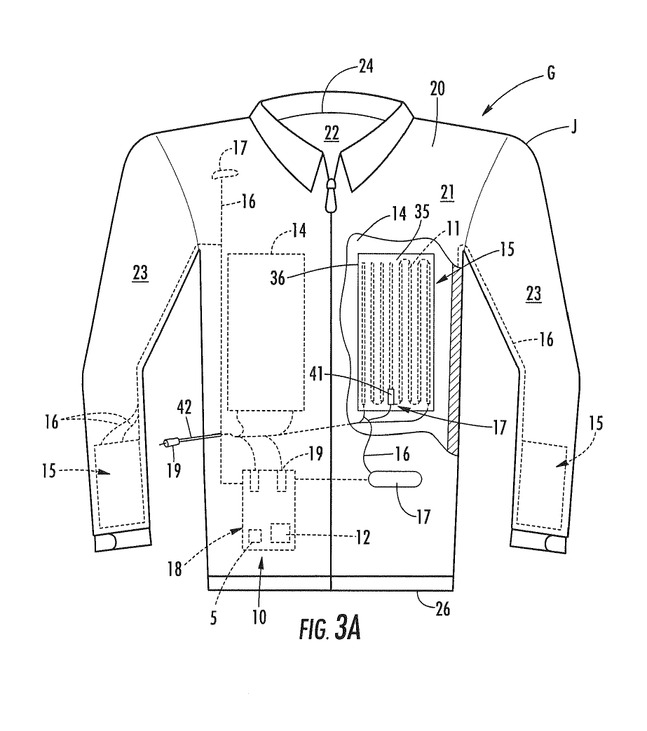

Referring now to the drawings in which like numerals indicate like parts throughout the several views, the present inventive concept shown in FIGS. 1A-11B is directed to a heating control system 10 for self-governing, thermally regulated or heated apparel/garments G (FIGS. 3A-3C and 5A-7B) and/or other articles or devices or systems (FIGS. 4A-4B) and related methods of control for such self-governing thermally regulated apparel/garments (FIGS. 8-18C). In one embodiment, thermal output or heat applied through the apparel/garment item or other article G will be controlled via the heating control system 10 through the regulation of the application of electrical power from a power source 12 to an electrically resistive heating element 11 of one or more integrated heating assemblies 15 integrated into the apparel item or garment, such as by fitting in a pocket 14 (FIG. 3A). A user, i.e., the person wearing the apparel item or garment, can engage the heating control system 10 via an apparel controller unit 18 (FIGS. 1-2A) to determine/select and input or set a desired or acceptable thermal output i.e., corresponding to a desired level of heating or temperature or range of temperatures felt by the wearer or user based upon monitored data sets or values. Such a controller can be mounted, attached or otherwise incorporated and integrated into or with the garment/apparel or device being controlled, such as shown in FIGS. 1 and 3A-3B; or can comprise a wireless controller, as shown at 18A in FIGS. 2A-2B, or can comprise a wireless device such as a Smart Phone 101 with wireless connectivity for use as part of a wireless heating control system 100 as shown in FIGS. 8-11B.

Feedback information for use by the controller and/or user can include use of direct temperature measurements of the heated garment or item and/or the surrounding environment. In addition, other types of measured values can be used to correlate and control the thermal output supplied by the heated garment or other article. For example, the controller 18 can receive a measured electrical resistance or voltage value across the heating element from a sensor 17, such as a thermistor or thermocouple imbedded in one or more heating assemblies 15 of the apparel item or garment. Thereafter, the apparel controller unit can operate to substantially automatically regulate the thermal output or heat applied by the heating assemblies of the apparel item by monitoring and/or receiving measured feedback values of electrical resistance (i.e., from the thermistors imbedded within such heating assemblies), and accordingly adjusting the power level applied to the heating assemblies if detected electrical resistance values fall outside of the previously recorded or predetermined/set resistance value or range of values.

More or less power can be provided to the heating elements of the heating element assemblies to heat the apparel item decrease the application of heat thereto by increasing or decreasing the electrical resistance until the monitored electrical resistance values were detected as within a desired range or meeting a desired or preset value. Operation of the present system for control of self-governing thermally regulated apparel or heated garments thus can be controlled substantially independently of the actual temperature of the garment, and without requiring monitoring and recording of varying actual temperature values at one or more locations along the thermally regulated or heated apparel/garment. Instead, the thermally regulated apparel or garments of the present invention enable the use of lower cost monitoring or measuring equipment that further can be installed, imbedded or otherwise applied to the self-thermally regulated or heated apparel/garment without substantially adding to bulk or otherwise adversely affecting the comfort and movement of the user wearing such a garment.

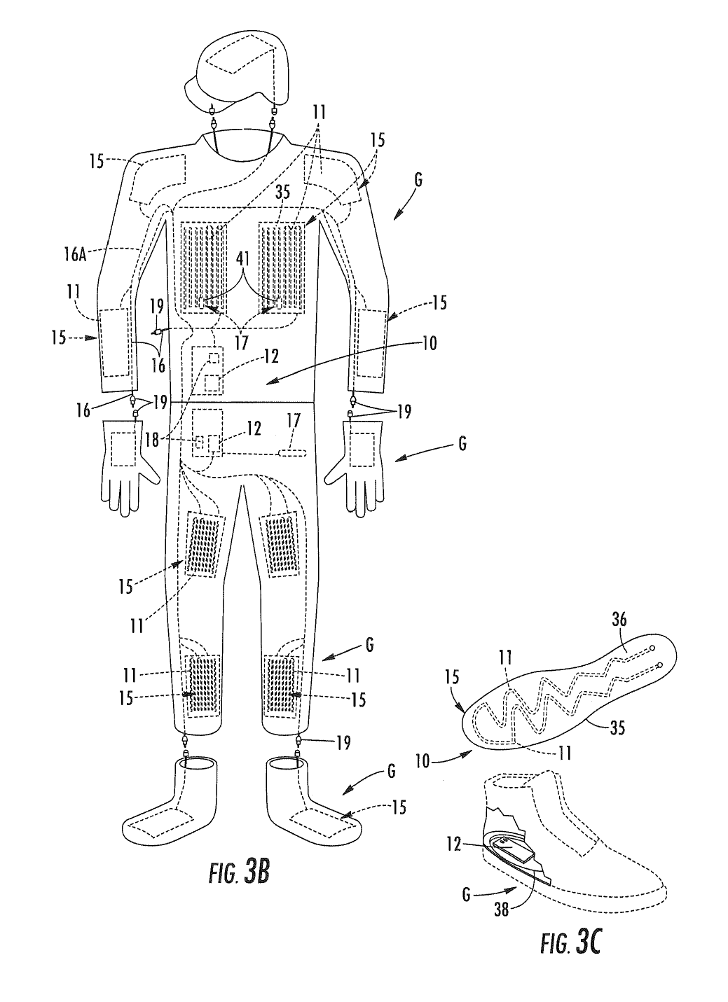

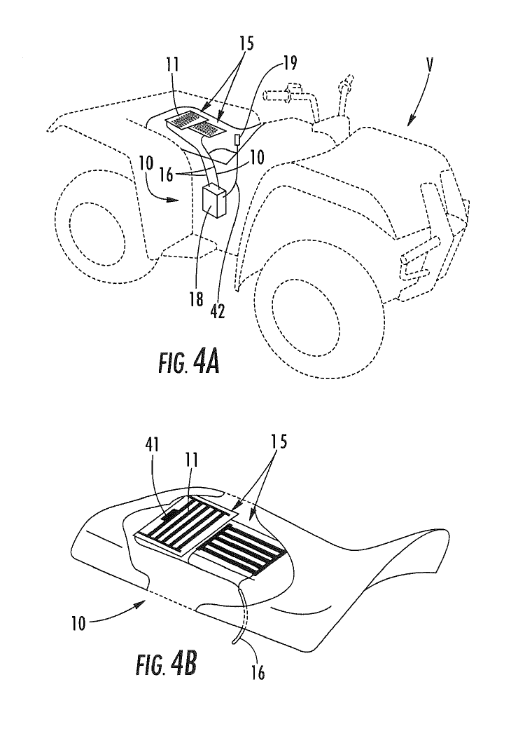

FIGS. 1-2B illustrate embodiments of an apparel control unit 18 for use with the control system 10 for self-governing thermally regulated or heated apparel or garments or other devices of the present invention, various examples embodiments of which are shown in FIGS. 3A-4B and 5A-7D. While the Figures illustrate the use of particular devices, articles, apparel items or garments G, such as a shirt S as shown in FIGS. 5A-5C, jacket J (FIGS. 3A-3B), a boot B or shoe (FIG. 3C), or various other devices or articles, such as a vehicle seat V, as shown in FIGS. 4A-4B, it further will be understood by those skilled in the art that the self-governing thermally regulated apparel or heated garments and control system therefor can be applied to a variety of other types of garments or items of apparel, including, but not limited to, jackets, coats, windbreakers, vests, pants, shorts, leggings, undergarments, socks/shoes/boots (and/or inserts therefor), hats, as well as various other, similar heated devices or items incorporating or otherwise including heating assemblies or systems for internally heating or thermally regulating such items as indicated in FIG. 3B. Such apparel items or garments further can be interconnected and controlled in series or as a connected/whole body apparel system or one-piece suit as is further illustrated in FIG. 3B.

For example, as shown in FIGS. 3A-3B and 5A-5B, a jacket J or shirt can include a body 20 formed from panels 21-22 which include one or more textile-based heating element assemblies 15 that can be sewn, inserted, attached or otherwise integrated into the body 20 of the jacket or shirt at spaced locations, such as along chest or back portions thereof, being received within pockets or mounted using releasable fasteners. The heating elements 11 of the heating element assemblies 15 can be configured in varying sizes and shapes as needed depending upon the particular application. For example, as shown in FIGS. 5A-5C, larger heating element assemblies 15 or pads can be used for a jacket or shirt to provide broader application of heat, while smaller articles such as gloves, socks and/or boots generally can have smaller or other varying sized heating elements, as indicated in FIGS. 3B-3C. An example of the textile based heating elements for use in the heating system 10 of the present invention are disclosed in published patent application 2008/0223844 A1, and U.S. Patent application No. 14/496,603, the disclosures of which are both incorporated by reference as if fully set forth herein.

The heating control system 10 of each heated garment or device to be linked and controlled also generally will include a controller unit 18 (FIGS. 3A and 5C) to which the heating elements or pads are linked via conductive wires or leads 16 that can be pre-sewn into the garment or can be inserted along channels 16A formed therein. The controller can include an internal power supply 12, or can be provided with a connection or connectors for linking the controller 18 to a separate power supply. For example, the controller can include a rechargeable or replaceable battery 12 mountable to or integrated into the controller 18 as shown in FIGS. 3A-3B, it can have releasable connectors for receiving and electrically coupling a replaceable battery pack or series of batteries thereto, and/or further can include additional, external connections or leads 42 (such as with plug-in connectors 19) for connection of the controller and/or any power source of the heating control system 10 to an external power supply, as indicated in FIGS. 3A-3B and 4A, for providing additional power as needed and/or recharging of the battery pack or other power supply. The controller 18 further generally can include a processor storage memory and/or other internal control features/functionality for regulating electrical power supplied from the power supply to each of the heating elements 11 of the connected heating element assemblies 15, including the capability of recording and setting a desired temperature or range of temperatures and applying varying power as needed to adjust or regulate the amount of heat applied by the heating elements to substantially match the selected or desired temperature or temperature range for the heated garment or device. As also indicated in FIG. 3B, a series of garments or devices can be connected together, such as by plug-in connections 19, for control of their heating systems as a collected unit, or according to a “zone-by-zone” basis.

Still further, the heating control system 10 generally will also include one or more sensors 17 (FIG. 1) connected thereto or integrated therewith. For example, in some embodiments, one or more temperature sensors can be incorporated into a heated garment at varying locations and can provide monitored temperature feedback information to the controller 18. This monitored temperature information can be communicated to a wireless control device, such as wireless control module 18A of the controller 18, shown in FIGS. 2A-2B, or other device such as a Smart Phone 101 (FIGS. 8-11B). If multiple temperature sensors are incorporated into the garment or device, the monitored temperature information or feedback therefrom can be received and processed, such as being averaged, to provide an indication of an overall temperature throughout the heated garment or device. Alternatively, the monitored temperature information from each of the sensors could be separately communicated to the controller, such as to provide an indication of hot spots or colder areas of the heated garment or article. Still further, for existing garments or devices without integrated temperature sensors 17, one or more temperature/measurement sensors can be attached or provided as part of the control system 10, such as by plug-in modules that connect to the heating element assemblies 15 or leads 16 as shown in FIG. 3A; or as a further alternative, the resistance of the heating elements can be measured by the controller or sensors, such as thermistors 41, linked thereto and used to determine a feedback temperature value, for example expressed as a percentage setting (e.g., 1-100%) of heating level applied or temperature.

FIGS. 5A-5B illustrate one example embodiment of a self-governing thermally regulated apparel item or garment G incorporating the heating control system 10, here illustrated as including a shirt S, or jacket, for example including a garment body 20 formed from various fabric or textile materials, with first and second or front and rear portions of panels 21-22. Sleeves 23 can be attached thereto and an upper or neck opening 24 and lower or waist opening 26 fanned therealong. One or more heating assemblies 15 can be applied to one or both of the first or front and second or rear portions 21/22 of the garment body 20. In embodiments such as illustrated in FIGS. 5A-5C, multiple heating element assemblies 15 can be utilized, with, for example, one located along the back portion 22 and one along the front portion 21 of the garment body. It will, however, also be understood by those skilled in the art that while a single heating assembly can be used, in some applications, multiple heating assemblies 15 also can be used, including additional heating element assemblies applied along sleeves or other portions of the garment, such as indicated in FIG. 3B. Such multiple heating assemblies can be linked in series or arranged in zones such as a chest/torso zone “Z1,” shoulders “Z2,” and/or arms and hands “Z3,” which zones each can be independently linked to the controller 18 or to a zone identified controller for control of the thermal output provided thereby.

The integrated heating element assemblies 15 each can comprise a body 30 or unitary assembly that can be formed as a substantially flat and flexible pad or similar member 30A and which will be applied to or otherwise incorporated into the garment. For example, as indicated in FIG. 3A, each heating element assembly 15 can be sewn, glued or otherwise attached along an inside surface of the front and/or back panels of the garment, can be inserted into a pocket 14 or other enclosure formed in or attached to the garment G, or can be placed between multiple plies or layers of the front and back panels of the garment and thus substantially fully integrated into the body 20 of the garment with the attachment of these plies.

Additionally, as indicated in FIGS. 3B and 5A-5B, passages (shown at dash lines 16A) further can be provided along or within the garment body adjacent the heating element assemblies for connecting the heating element assemblies to the apparel control unit. For example, open ended passages or channels 16A can be formed along the body of the garment, such as in instances where the heating element assemblies 15 received within pockets 14 formed in the garment body 20 or contained between multiple plies of the garment body, through which conductive wires, leads, conduits or cables 16 can be run. Such wires or cables enable the transmission of electrical power and/or the communication of monitored electrical resistance or voltage measurement values between the controller unit 18 and each of the heating element assemblies 15 of the garment. Alternatively, such cables 16 can be sewn, adhesively attached or can be clipped or otherwise applied/attached along an inner surface of the garment body. The cables or wires also can include detachable plug-in or releasable connectors 16B at each end thereof for connection of the heating element assemblies 15 to the controller unit 18 which further can be provided as a removable controller that is attachable/detachable from the garment or which can be a separate controller/system, and/or to a power source, as needed, to enable quick and easy replacement thereof.

The body 30 of each of the integrated heating element assemblies 15 also can be foamed in various configurations. For example, as illustrated in FIGS. 5A-7D, in one embodiment the heating element assemblies can be configured to generally match the shape or configuration of the garment or a portion thereof, such as having a substantially “T” shaped configuration, and with the heating element assemblies applied to the front and back portions of the garment being substantially inverted to provide a desired coverage area to the garment. Other configurations or designs of the heating element assemblies also can be used, as indicated in FIGS. 3A-4B.

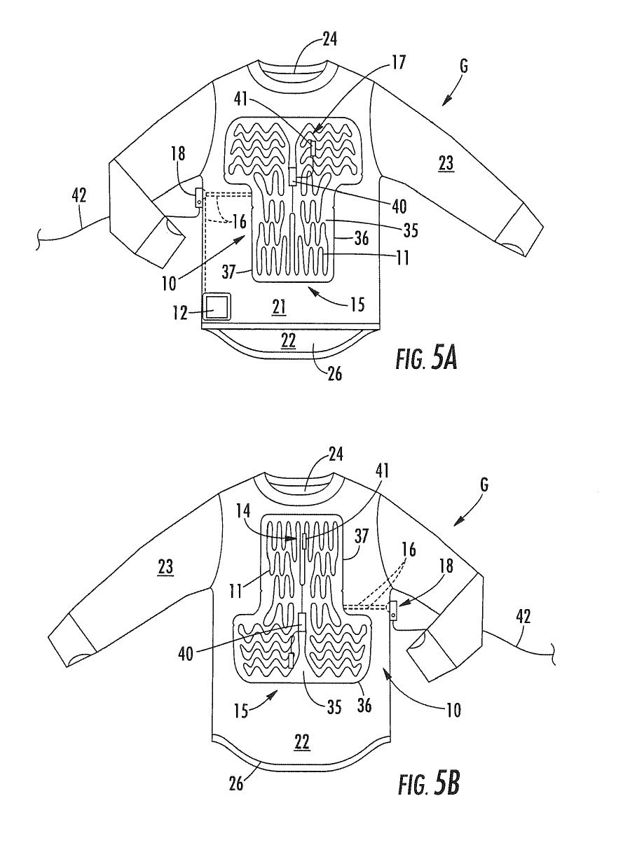

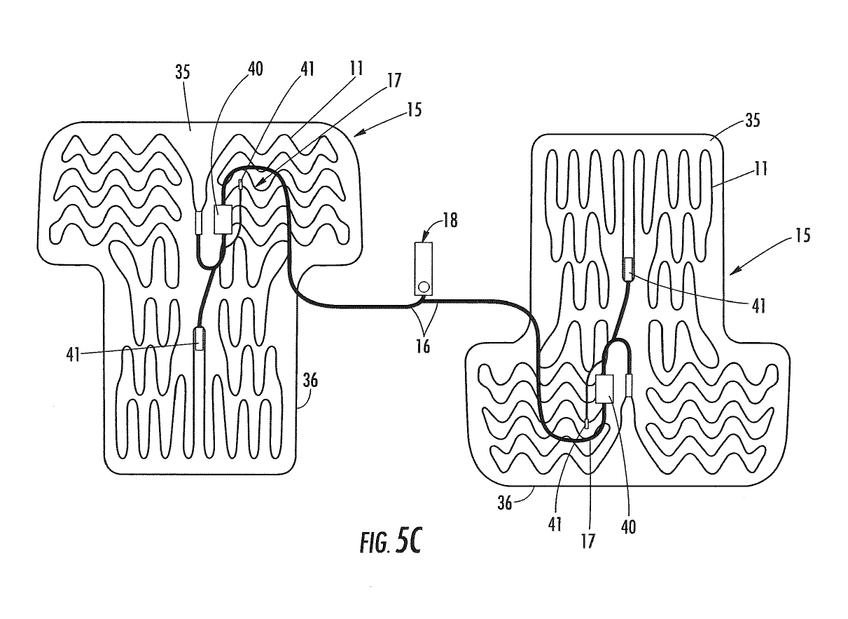

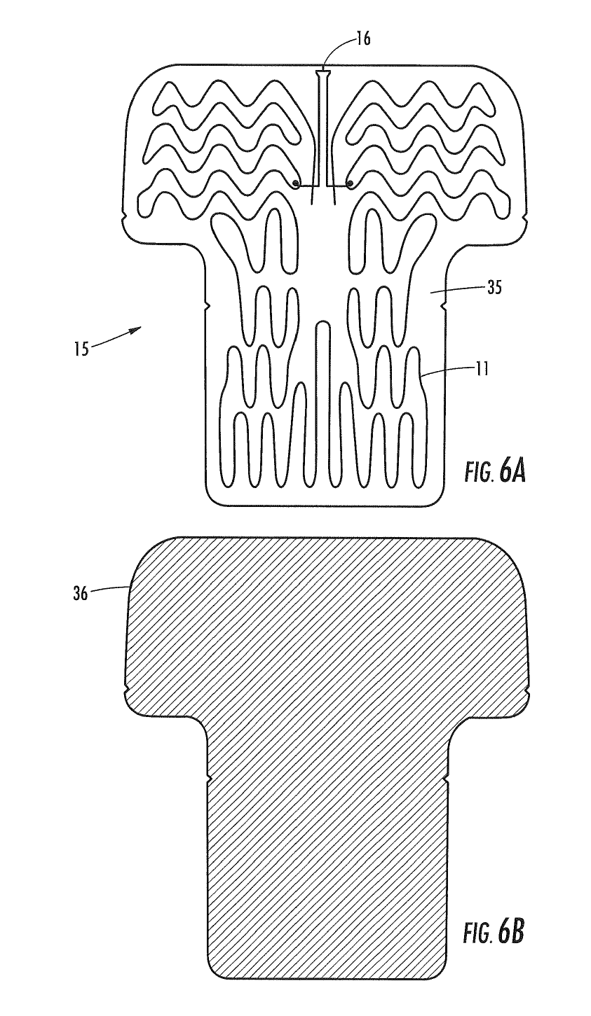

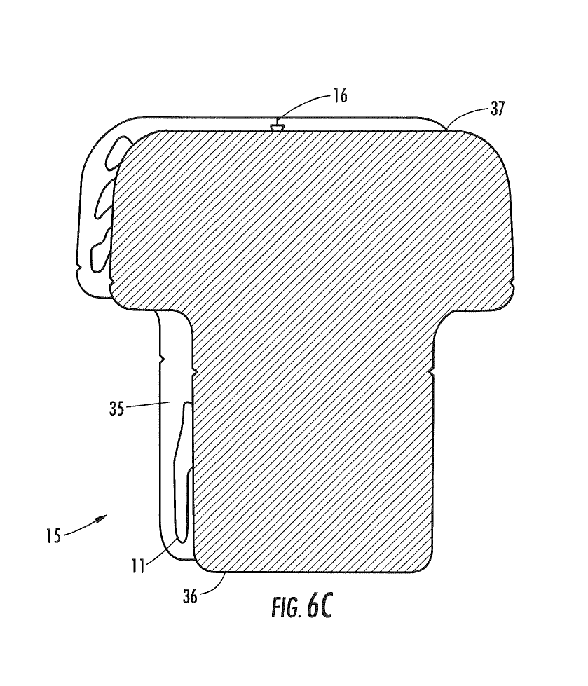

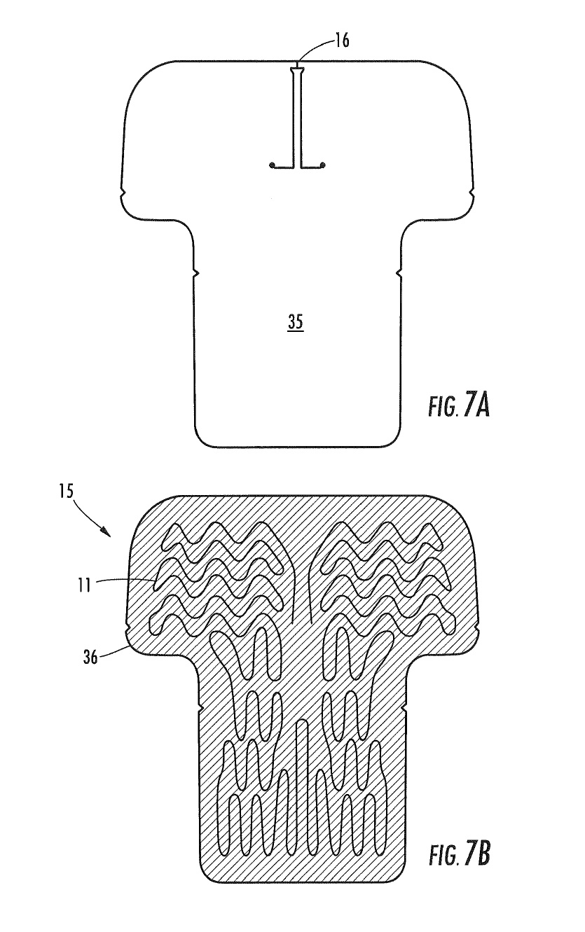

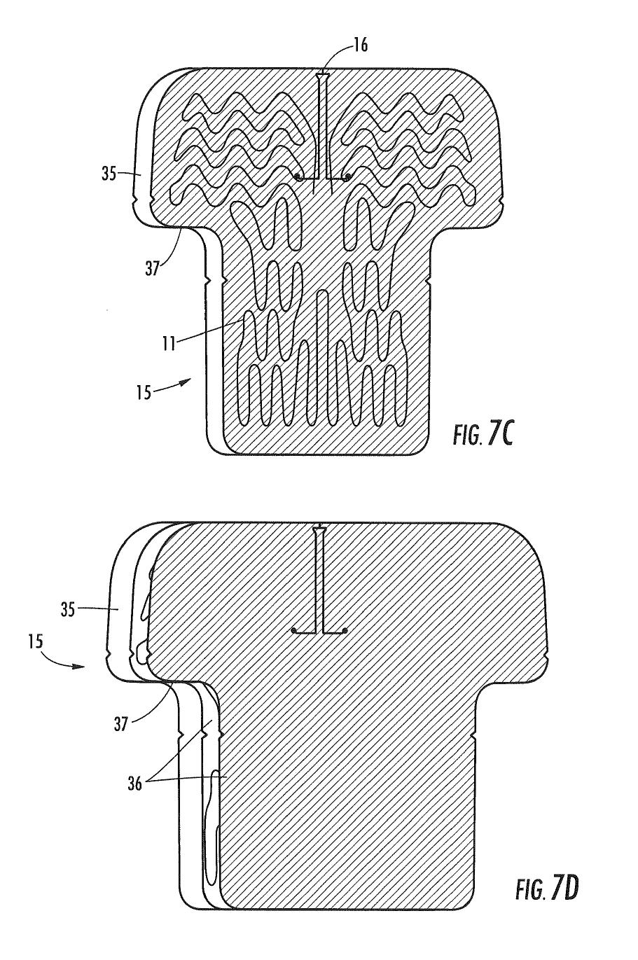

In some embodiments, such as shown in FIGS. 6A-7D, the body 30 of each integrated heating element assembly 15 can include a base layer or substrate 35 along which a heating element 11 will be applied. A layer 36 of a shielding fabric material, which can include an electromagnetic or other electrical interference shielding material, and/or other insulating material to protect against contact with the heating element materials, also can be applied/attached. The substrate 35 and shielding fabric layer(s) 36 generally can be attached together by stitching or other attachment means applied about the perimeter edges 37 thereof The base layer or substrate 35 further typically can include a flexible insulating fabric material, such as cotton or other, similar flexible fabric material that allows transmission of heat therethrough but will protect the wearer from direct contact with the electrically resistive heating element material 11 of the heating element assembly. The shielding fabric layer and/or the substrate also can include a durable rip-stop type fabric, such as a silver threaded or lined rip-stop style fabric, including layers or integrated materials that are insensitive or resistant to electromagnetic and/or other types of electrical interference.

The heating elements 11 of each of the heating element assemblies 15 generally can comprise an electrically resistive heating element or wire formed from conductive filaments or thread formed from silver, steel or stainless steel, copper, nickel-chrome, gold, carbon fiber or other, similar conductive fibrous materials, can be applied in a desired pattern onto the substrate as shown in FIGS. 5A-6A and 7A. In one embodiment, each electrically resistive heating element 11 generally will be attached to the substrate by overlock stitching so as to attach or secure the electrically resistive heating element to the substrate and with the ends of the electrically resistive heating element generally being linked to an electrical connector or coupling 38. The electrically resistive heating element 11 also typically can be applied in a substantially non-linear pattern, for example, in a generally zig-zag pattern as shown in FIGS. 5A-6A, and extending across and along a substrate, with the pattern being selected to enable maximum coverage or application of heat thereby. Other patterns also can be used. Alternatively, the electrically resistive heating element also can be attached via adhesive or other means or can be secured between the substrate 35 and shielding or insulating layer 36 by the attachment or connection of the shielding or insulating layer and the substrate, such as by stitching applied along the peripheral edges 37 thereof. As a result, a substantially integrated or unitary heating element assembly 15 including an electrically resistive heating element 11 that is flexibly supported by the substrate and which can include an EMI protective shielding and/or insulative covering thereover is provided, which enables substantially self-governing thermal regulation or heating control while further protecting the user and the electronics and/or controller functionality of the system from electromagnetic interference.

FIGS. 7A-7D illustrate further alternative embodiments of the heating assemblies 15 for self-governing thermally regulated apparel with additional shielding/insulating protection. In the embodiment illustrated in FIGS. 7A-7D, the electrically resistive heating element 11 can be sewn or otherwise applied to or integrated directly into/with an EMI shielding fabric layer 36. Thereafter, a substrate or insulating layer 35 can be applied thereover and attached, such as by perimeter stitching 37, adhesive, or other means. Additionally, to the extent that additional EMI or other interference shielding is necessary, depending upon the application or use of the self-regulated thermally regulated apparel item or garment, further layers of fabric shielding materials 36 (FIG. 7C) can be applied thereover.

In another embodiment shown in FIG. 3C, the heating control system 10 can be used for control of shoes or boots B. As indicated in FIG. 3C, the boots B generally can include heating assembly 15 formed as a foot pad or boot liner “L,” including a pad/substrate 35 on which the heating element 11 is arranged, and an insulating layer 36 applied thereover. The liner L can be integrated into the boot B, or can be a removable/replaceable liner, thus enabling replacement of worn or damaged liners or substitution of different liners (e.g., different type or thickness pads, and/or varying thermal outputs) to match user preferences or requests. For integrated pads, the heating element 11 of the liner can be directly linked to a battery or other power source 12 housed within the boot, such as in a compartment 38 defined within the heel of the boot, or alternatively, can be integrated into the liner L within or between the substrate and insulating layers. As a further alternative, the liner L can be removable, and can be provided with an integrated battery and controller 40 (which also can include Bluetooth® communications), or can include a detachable connector, here shown as contacts 39A, that mates with a corresponding connector, such as contacts or terminals 39B, for the power supply within the compartment 38 of the boot B. Pressure of the user/wearer's foot in the boot and on the liner can create and maintain the electrical contact therebetween. Other types of connections, such as a snap-in or plug-in connections also can be used. The battery 12 further can be removable from and replaceable within the compartment 38, such as by removal of a sealable cover 38A, or can comprise a rechargeable battery or other power source sealed within its compartment and being rechargeable by connection to an external power source, such as by a cable or by inductive recharging.

Additionally, each of the integrated heating assemblies 15 can further include an internal control module or processor 40 mounted between the substrate and shielding layer thereof (FIGS. 5A-5C). The control module 40 can function as an additional or back-up control to regulate application of heat by the heating assemblies, thus acting as a secondary control unit, and generally will be linked to both the electrically resistive heating element 11, such as by the ends of the wire or conductive filament thereof plugging into or otherwise being connected to the control module 40. The control module 40 also generally can be linked to one or more temperature measurement devices or sensors 17, or other measuring devices or sensors such as thermistors 41, or thermocouples, mounted along the length of the electrically resistive heating element.

For example, in one embodiment, the control module 40 can receive and monitor temperature or other values such as the electrical resistance provided by the one or more thermistors 41, or alternatively, can measure voltage levels across the electrically resistive heating element via thermocouples, and in turn will communicate this information to the apparel controller unit 18. The apparel controller unit can be integrated into or attached to the body of the garment, and/or can be coupled to or integrated with a power source 12. The power source 12 further can be integrated into the garment as indicated in FIG. 5A, such as mounting to the garment or fitting into a receptacle or pocket, into/with the controller unit itself, or with or as a part of each control module 40, or can be a separate power source connected thereto by an input conduit or cable 42, as indicated in FIG. 1. Typically, the apparel controller unit can be connected or attached along an area or portion of the garment body that will enable access and operation thereof, without interfering with the wearer's movement or performance of tasks, etc., while wearing the self-governing thermally regulated apparel item or garment. In one example embodiment illustrated in FIGS. 5A and 5B, the apparel controller unit 18 is shown as being mounted along one side of the body of the garment adjacent an underarm or sleeve portion thereof. Other placements or locations also can be used.

The thermistors utilized in the self-governing thermally regulated apparel or heated garments of the present invention can include a variety of different types of thermistors, including substantially lower-cost thermistors, such as thermistors that can incorporate up to a 20% tolerance or margin with respect to electrical resistances measured thereby. In addition, the thermistors utilized do not have to be closely calibrated or selected for substantially tight tolerances or direct correspondence with specific, actual measured temperatures. Instead, the user or wearer can select or correlate a measured resistance value based on their own warmth/comfort level, enabling them to program or set the apparel controller unit to apply/adjust a power level at which a desired amount of heat or thermal output is applied by the garment based upon a theoretical heat transfer growth in view of the recorded electrical resistance value or a range of values corresponding to such a desired, user preferred or prescribed thermal output. Thereafter, the apparel controller unit 18 can receive monitored or measured electrical resistance values measured or detected by the one or more thermistors mounted within the heating assemblies via the control module of each heating assembly.

Demonstrative embodiments may also include the use of a thermocouple wherein the controller unit records the voltage level of the thermocouple as the value of interest. In instances where economic considerations dominate, the apparel controller unit may incorporate thermocouples with an operating tolerance of approximately 1% up to approximately 20% or greater.

The control modules 40 of each heating assembly 15 can be configured to record or detect thermistor electrical resistance values at preset intervals and can communicate this information to the apparel controller unit, either substantially in real time as such measurements are being recorded, or at a further interval such as may be needed to conserve power of an internal power source or supply. Where multiple thermistor resistance measurements are provided, the apparel controller unit 18 can be configured to use such information, such as by averaging the received measured resistance values for the garment, or by display and/or control of the heating assemblies of the garment as separate zones, as indicated in FIG. 2B. The apparel controller unit 18 further can be removable or can be provided as a separate unit that can be connected to each of a series of heating assemblies 15, as indicated in FIG. 3B, and further can connect to an external power source or an external control. For example, the apparel controller unit, or a series of controller units, can be included as part of an environmental control system such as for an aircraft cargo bay or inside a vehicle to provide monitored feedback and control for a variety of different and/or interconnected garments, and can be configured to allow a user to control such interconnected garments separately. In further alternatives, as shown in FIGS. 2A-2B 8-11D, the apparel controller unit 18 can include separable parts, including a first or wireless control part 18A, and a second, base or receiver part 18B, or can interface and link with a user's own personal wireless device 101.

In some embodiments, the controller unit 18 can contain two or more channels, where each channel of the controller unit is capable of independently communicating with one or more sensors and/or control modules 40 for detecting and recording temperatures or electrical values of an associated or selected thermistor or thermocouple linked to an identified control module 40 or to a wireless transmitter attached to an apparel item. The user can engage a particular channel on the controller unit once a desired thermal output is achieved for the particular apparatus or apparel item associated with that particular channel on the controller unit. The controller unit will then detect and record a temperature value or setting, such as an electrical resistance value of a thermistor. This allows the controller unit to read and record temperature/electrical resistance/voltage values for a multitude of heating element assemblies 15 and/or garments, each of which is associated with a particular channel on the controller unit. The controller unit further will be capable of applying varying power levels to keep the monitored values, such as electrical resistance, within a predefined or user settable temperature value range for a multitude of heating element assemblies and/or garments, each of which is associated with a particular channel on the controller unit, so as to facilitate control of the thermal output, and thus the temperature, felt by the wearer of the thermally regulated garments substantially automatically, and on a region or zone basis. For example, with a connected suit of garments such as shown in FIG. 3B, the wearer could control heating of feet, legs or torso as zones, or further could control individual areas of a garment such as the chest 21, shoulders 22 and arms 23 or hands of a shirt or jacket and gloves.

Referring to FIGS. 1-2B, one example embodiment of a controller unit 18 is shown with two user/input controls 61/62, and a display 63, such as an LED, or similar indicator. A first user/input control 61 can comprise a user setting control and is configured to establish and transmit an electrical power output from an electrical power supply to the heating assemblies controlled thereby via one or more electrical power outlet connectors 64. An additional connector 66 (FIG. 1) also can be provided for separately linking the apparel controller unit to another controller or autopilot control system as needed. The electrical power output can be continuously repeated at a predetermined amperage and also for a predetermined frequency and duration, depending on a setting input from the user. For example, at a desired heating level, the user can engage the first control to set the power level going forward.

The second input or user control can be capable of being engaged and disengaged by the user. For example, it can be configured such that when it is initially engaged, an electrical resistance value of a thermistor is measured, or alternatively, a voltage level of a thermocouple is measured. Such measured values can be shown on the display 63 as the user varies the power output to the heating assembly, to provide the user with a visual indicator (i.e., a numerical value of 1-9 or other indication) of a desired thermal output level based on measured resistance/voltage levels. The user can then fix or set a desired level. While the resistance value and/or voltage level is measured, as long as the second control is engaged, the setting of the first control can be overridden. The electrical power output can be substantially automatically varied by the apparel controller unit such that the measured temperature, electrical resistance value of the thermistor, or the voltage level of the thermocouple remains relatively constant with respect to the initially measured and set/predetermined values. In other words, the monitored temperature, resistance value and/or voltage level is maintained within a predetermined range with respect to the initially measured and/or selected values. When the second control is disengaged, the electrical power output returns to the last electrical power output setting established by the first control. Thus, the user or wearer of the garment can set a desired temperature or heating/thermal output level and enable the heating control system to maintain the thermal output of each heating assembly of the garment approximately at the selected/set temperature or within a range thereof, without further user action to adjust the temperature setting, unless needed or desired.

Referring to FIGS. 2A-2B, the apparel controller unit 18 is further shown with two modules or parts 18A/18B, including a transmitter section or module 18A and a base or receiver section or module 18B, although each part can be capable of both transmitting and receiving wireless signals. The transmitter module 18A can provide wireless control functionality and can include the first input or user setting control 61, as well as an auto pilot user control or a second input or user control 62, which can include buttons, toggle switches or other manipulatable activators. The base or receiver part 18B of the controller unit 18 generally will be connected to the heating element assembly or assemblies and can include electrical input 66 and output connections 64 for controlling power from the power supply to connected heating assemblies. The transmitter also can include a display 67, such as an LED or LCD screen 67A showing a temperature or control valve and/or a battery status level indicator 67B, as well as include a connection/pairing status indicator 68.

The apparel controller unit further can include multiple independent operating channels 71/72 and multiple independent user setting controls, including a first user or input control, an auto pilot control, and/or second user or input control. In this embodiment, the first user or input control can include 2 or more buttons or switches 73 and an indicator 74 for enabling the user to switch between the 2 or more operating channels so as to enable control of multiple heating zones, for example multiple different parts, areas or locations of a heated garment, or for control of multiple linked garments, as shown in FIG. 2B. The second user control likewise can comprise 2 or more buttons or switches 76 (FIG. 2B) or a single toggle switch 72 (as shown in FIG. 2A) or similar switch mechanism, to enable user adjustment of the thermal output of the heating elements for each garment or zone. The receiver generally includes a connection to the power supply. The receiver also can include 2 or more independently controlled power output connectors 64.

In some embodiments, the power source 12 for the apparel controller unit and/or heating element assemblies can be incorporated into or detachably connected to the thermal-regulated apparel item independent of the use of the electrical connections of the apparel controller unit. The power source 12 can include one or more batteries, or similar replaceable and/or rechargeable power pack that fits into the garment or connects to and/or is part of the apparel controller unit, or can include a connection to an external power supply such as an electrical generator. Other exemplary embodiments may include thermally regulated, self-governing apparel items wherein the power source is a battery or replaceable/rechargeable power supply that can be integrated into and/or be removable from each heating element assembly of the garment. For example, FIGS. 3A-3B show the power source 12 mountable to or integrated with a controller 18. FIG. 3C shows a power source 12 mountable within the heel of a boot B; while FIG. 5A shows the power source 12 mountable to a garment. In other embodiments, as shown in FIGS. 4A-4B, the heating control system 10 can be operable with an external power source, such as by being capable of detachably connecting the thermally regulated apparel item and/or heating element assemblies thereof to a vehicle battery (i.e., a 12-Volt car or motorcycle battery) or other power source through an auxiliary port. Varied power source possibilities enable increased design and engineering flexibility, which enables the present inventive concept to be tailored to variety of fields of use or recreational activities.

Varying size and/or capacity power sources can be used depending on the size and/or number of heating element assemblies being powered. For example, 5 volt-7 volt power sources can be used for powering individual heating element assemblies. Larger power supplies, i.e., up to 12 volts or more, can be used to power multiple and/or larger heating element assemblies, such as for powering a connected series of garments (e.g., gloves, jacket, pants, etc.). The power supplied further can be regulated among the different garments or heating element assemblies via multiple power outlets of the controller unit to enable more individualized regulation of a series of garments, or for control of the thermal output thereof as a one-piece unit or suit. In embodiments where the apparel controller unit includes a wireless transmitter part/section 18A (FIGS. 2A-2B), this section or part 18A also can be provided with an internal power source, such as replaceable and/or rechargeable batteries, so as to be rechargeable by replacement of the batteries therein or by mounting the part on a cradle of dock, and/or can also include auxiliary power/data port connections. Additionally, where multiple power outlet connectors are provided by the article controller unit 18, one connector can be attached to one apparel item and another connector can be connected to a second apparel item to separately power/heat each apparel item, and with each different apparel item being regulated independently from the other.

The power source further could be connected to or integrated with a control module 40 (FIGS. 5B-5C) of an individual heating element assembly 15. For example, where the heating element assemblies are configured as replaceable pads that can be substituted for existing heating assemblies, such as a replaceable liner L (FIG. 3C) for a shoe or boot B, or which are mountable or attachable as an add-on or new heating assembly, such as for use in a vehicle seat (FIG. 4A) or in a shirt (FIG. 3A) the power source and control module can be provided together as a unit. A Bluetooth® transceiver or similar wireless communication functionality also can be integrated with the power source for sending feedback to and receiving control instruction changes/updates from a wireless controller such as a Smart Phone 101 (FIG. 8).

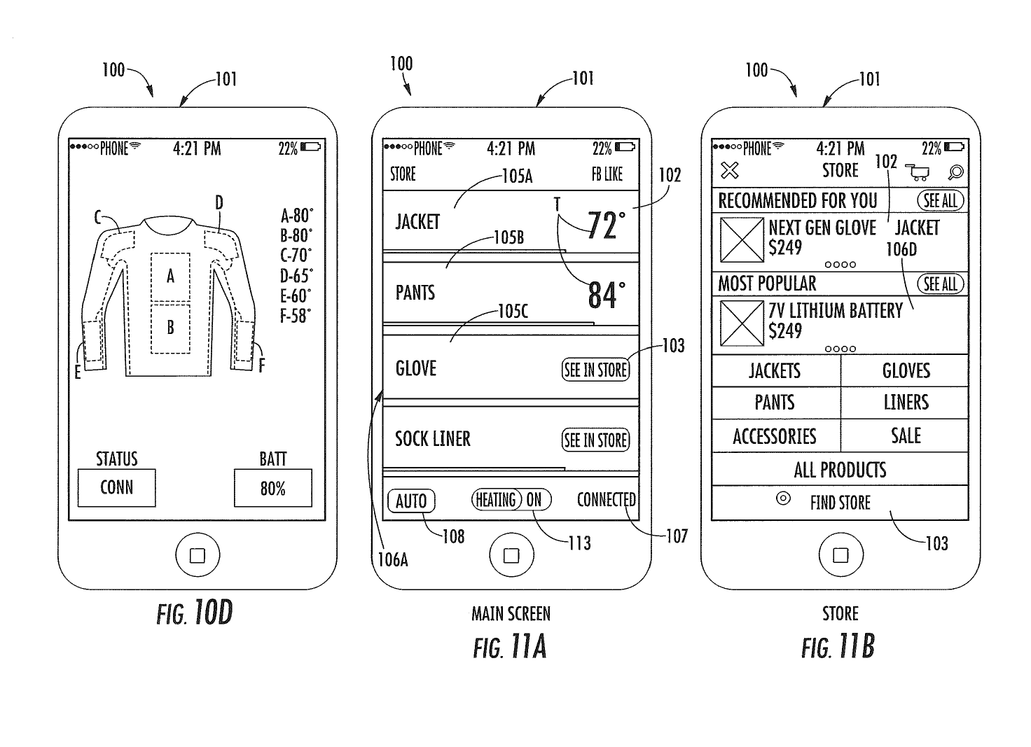

In further embodiments, the present invention is generally directed to a heating system or apparatus that can be incorporated into various articles or devices, and which incorporates wireless connectivity to enable the user to receive monitored feedback or data relating to the temperature of a heated article or device during operation of the heating system and application of heat thereby, wirelessly on a wireless control device such as, in one example embodiment, a user's Smart Phone 101. The heating system 100 further includes a wireless control heating system control application, as illustrated at 102 in FIGS. 8-16 that can be downloaded or programmed into a user's wireless control device 101, for example being downloaded to the user's Smart Phone via an online app store (as indicated at 103 in FIG. 11B) or other site, and which enables the user to monitor temperature levels of one or more heated devices and make adjustments thereto using their Smart Phone or other wireless control device. An icon 104 (FIG. 8) for the app can appear on the home screen of the phone. The wireless heating control system application further can be configured to support the monitoring and control of temperature levels for multiple, different heated garment devices or other articles, and thus can include multiple, separate controls for distinct adjustment of each heated garment or article connected thereto as needed or desired.

As noted above, the apparel controller unit 18 for each heated garment or article can include a wireless, Bluetooth® connector/controller 5 (FIG. 3A), which can be integrated as part of the controller, or can be a separate plug-in type module or device connected thereto. In a further alternative embodiment, the Bluetooth® connector/controller also can be integrated into/with the power supply 12 and/or as part of a control module 40 (FIGS. 5A-5C) integrated with a heating assembly 15, (FIGS. 5A-5B), so as to enable the power supply and/or control module of such heating element assemblies to interface directly with the user's Smart Phone or other wireless device. For example, removable or replaceable heating element assemblies or pads such as for use as inserts for garments or for other portable heating applications can be provided with a direct link or connection to a user's Smart Phone without requiring the garment to have an existing apparel controller. The Bluetooth® connector/controller will establish a two-way wireless connection between the control module and a wireless control device such as the user's Smart Phone, through which the control module will communicate monitored parameters of the heated garment or device, for example, the monitored temperature and/or power levels of the power supply therefor, for each of the heated garments or devices connected to the wireless control device by the wireless heating control system.

FIGS. 8-11B illustrate example display/control screens or pages 106A-106D of the wireless heating system control application 102 according to one example embodiment of the present invention. As noted, the application can be configured to run on a variety of different wireless control devices, including different manufacturer smart phones utilizing different operating platforms. For example, the wireless heating system control application can be configured to operate as an “Apple iOS®” application, or alternatively, could be used on other wireless control device or Smart Phone platforms including devices implementing the “Android®” operating system. In addition, the wireless heating system control application can be further programmed or configured to operate with a variety of different versions of Apple, Android and/or other operating software platforms, as well as to run substantially seamlessly with and/or support display on different screen sizes.

The firmware of the Bluetooth® connector/controller and control module of each heating system assembly being controlled, in addition to the software of the wireless heating system control application, further will be field updatable, with such updates being implementable via the wireless heating system control application and Bluetooth®/wireless communications link between the Bluetooth® controller of the heating system control module and the user's Smart Phone or other wireless control device.

As noted, the wireless heating system control application 102 generally will include a series of control screens or pages 106A-106C, including a main heating system control page 106A that can be directly accessed such as through an application icon on the user's Smart Phone. Examples of such an application heating system control pages are illustrated in FIGS. 8-11B. As shown, the wireless heating system control application can be configured to support separate, selectable control of multiple heated garments or devices. For example, a series of heated garments or devices, shown at indicators or icons 105A-105C in FIGS. 8-10A as including jacket, pants and gloves, each can be separately connected to and individually controlled via the wireless heating system control application on the user's Smart Phone. Additional or fewer garments or devices also can be controlled. Each of the Bluetooth® controllers connected to or integrated with the control modules of the heating systems for each paired garment or device can provide a distinct identifier thereof, and can establish a separate communication link with the wireless heating system control application running on the user's Smart Phone. For example, as shown in FIG. 9, where the heating control system controller(s) include multiple channels, each garment can be linked or connected on a separate control channel.

In one embodiment, the Bluetooth® controllers for the heating control systems to be used with various garments or devices can be programmed to support and/or pair or link a specific garment or device to the user's Smart Phone via the control application; and can utilize differences in communication frequencies to establish a separate two-way communications links between the heating systems of each of different heated garment or device being controlled and the user's Smart Phone or other wireless control device. The wireless heating control system application thus will support independent regulation of the temperature of each connected heated garment or device, each of which can be provided with a Bluetooth® controller configured to automatically identify the specific garment or device being controlled upon pairing with the wireless heating system control application, and which application can include and/or support a series of downloadable software modules or plug-ins for each specific type or identified garment or device to be paired and thus controlled. For example, as illustrated in FIG. 11B, software updates or modules to enable linking of a particular garment or type of garment can be downloaded from an application store or site, and can update the heating system control application on the Smart Phone to enable communication with and control of the associated garment. Once paired, the pairing a Bluetooth® controller for a specific garment type can be retained through power loss, although the user will be provided with the ability to remove the pairing for a garment or device as needed through other application control screens.

A connection status tab or bar 107 (FIGS. 8-9) also can be provided, indicating connection of one or all of each heated garment or device paired to the user's Smart Phone and to be controlled. For example, upon selection of a particular garment on a home screen such as shown at 106A, the status tab can indicate a connected/not connected state via color or illumination and can be engaged or touched to reestablish or deactivate a connection as needed. The Bluetooth® controllers can be configured to automatically link or connect to the user's Smart Phone or other wireless device to the heating system of each paired heated garment or device being engaged or turned on, as well as queries for the connection of additional heated garments or devices made. Alternatively, the Bluetooth® controllers can be maintained in a dormant or minimal power operation state while the heating system of the heated garment or device associated therewith is turned off, and the heating system can be activated by the user sending a signal through the wireless heating system control application on their Smart Phone (such as by engaging a connection status tab 107, or by an auto connect tab 108, as shown in FIG. 9) to connect to the Bluetooth® controller to wake-up and engage or activate the heating system and set desired temperature levels.

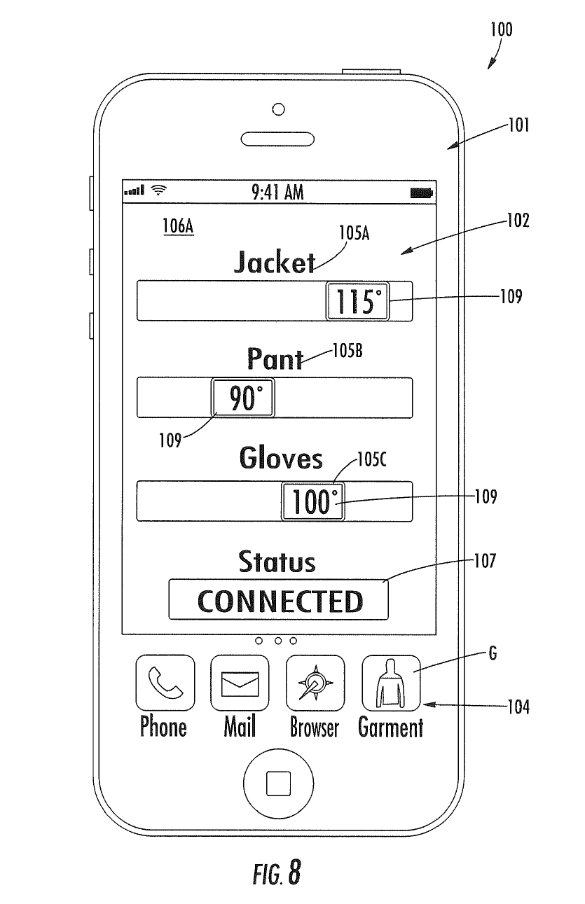

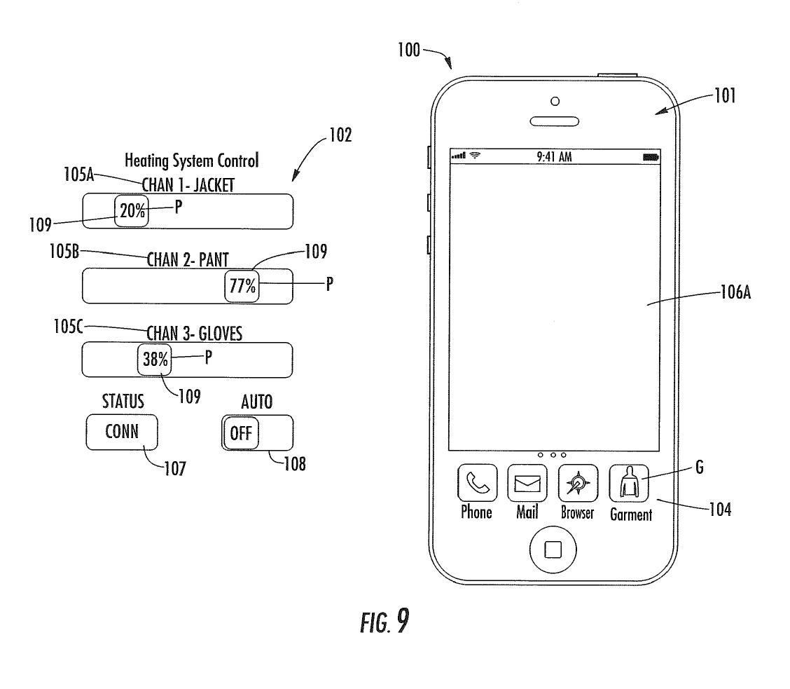

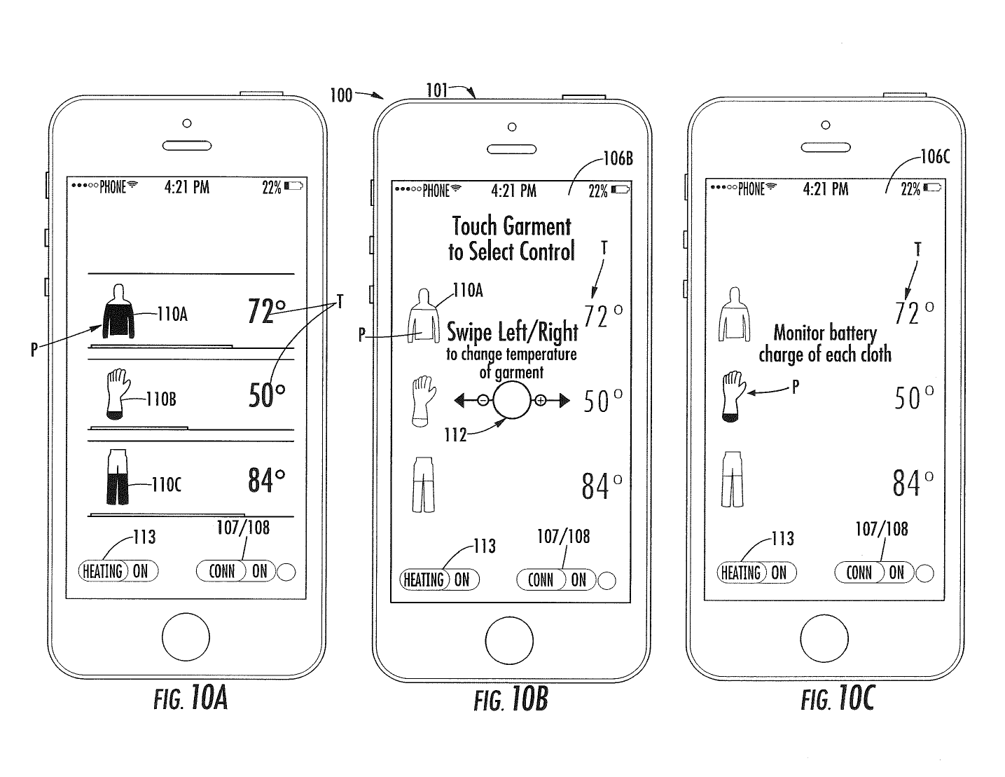

As further indicated in FIGS. 8 and 10A-11A, the wireless heating system control application 102 can separately display the monitored temperature levels T of each of the garments or devices linked thereto, and can also provide feedback or indicators of other aspects or parameters of the paired heating systems. For example, as indicated in FIGS. 10A and 10C, the temperature and power supply of each heating system can be monitored and a visual indication of amount of remaining power P of the power supply of the heating system of such paired heated garment or device can be displayed. Such a display of temperature and/or power levels can be by selecting a desired garment to check (FIG. 10C), as a part of the display in a status tab/indicator bar 109 (FIG. 9) for each garment being controlled, or by color, such as indicated by the various shaded icons 110A-110C in FIG. 10C. The battery status for each garment or connected series of garments or devices can be monitored and displayed/updated at periodic intervals, such as based on time or battery usage, and updates, including low battery conditions, can be sent to the user's wireless device to provide an alert.

As also indicated in FIGS. 8-10A and 11A, each heated garment or device connected thereto can be displayed either by name identifier 111—i.e., “jacket,” “pant,” “gloves”—or by a symbol such as garment icons 110A-110C (FIG. 10A) with the monitored temperature thereof also being displayed. Temperature displays T can be made in Fahrenheit or Celsius or both. The temperature and other parameters, such as a remaining power level of each paired heated garment or device, also can be displayed, such as by number value or percentage number and/or graphically by location of the tab 109 (FIGS. 8-9) along a sliding scale, by color, or other visual indicator. For example, FIGS. 10A-10C illustrate control/display screens in which each icon or picture 110A-110C of a heated garment such as a shirt or jacket, gloves and pants, are displayed with portions thereof being shaded or variably colored to indicate detected power charge levels.

As also indicated in FIGS. 8 and 10B, the user can selectively adjust the amount of heat applied by the heating system of each heated garment or device paired or connected to their Smart Phone or other wireless controller through the wireless heating system control application using touch screen functionality of the wireless control device. For example, as shown in FIGS. 3-9, the user can simply touch and slide tab 109 or the button corresponding to the desired/selected heated garment or device to be controlled to the left or right to adjust its temperature setting. Alternatively, as shown in FIGS. 10A-10B, the user can touch a selected heated garment or device icon 110A-110C displayed on a main or home control screen 106A to select a desired garment to control and thereafter can selectively adjust the desired temperature therefor, such as by pressing or swiping right or left arrows 112 on a secondary or garment control screen 106B or other control keys. Once a desired temperature level is reached, the user can simply release the control button, or can be queried to confirm their adjustment. Thereafter, the Bluetooth® controller will receive and communicate any desired temperature adjustments to the heating system control module for the selected heated garment or device and can provide feedback for maintaining the garment or device approximately at within a desired temperature range set therefor. A user can also selectively turn off a garment or selected heating assembly, such as by selecting the garment and engaging a heat on/off tab or button 113, as indicated in FIGS. 10A-10B.

In addition, FIG. 10D illustrates another embodiment in which a thermally regulated or heated garment can be controlled by zone or individualized heating element assembly. For example, the chest portion, including one or more heating element assemblies applied therealong, of a garment can be designated a first zone Z1, each arm (or part thereof) can comprise second and third zones Z2/Z3 and the back portion a fourth zone Z4. Each zone, or selected/linked heating element assembly, can be individually monitored and controlled via the Smart Phone wireless heating control application. Users can touch a desired zone or heating element assembly to select for control adjustments. Alternatively, the heating control zones can comprise different garments of a connected series or suit such as shown in FIG. 3B; for example, with control of the heating of the torso (e.g., a shirt/jacket and gloves) comprising one zone, the legs (pants and socks or boots) being another zone, and a hat or ski mask covering a wearer's head and neck and/or a connected heated device, such as a vehicle seat or tent, etc., comprising still further heating control zones.

The wireless heating system control application can also be provided with settable temperature ranges or limits (for example approximately 90° F. through approximately 130° F.) to prevent overheating or undue battery drain on the heating systems being controlled. Default temperature or thermal output levels also can be programmed as needed. For example, if the detected power level of the heating system of a paired/connected heated garment or device drops to or below a preset level, e.g., 20-25% or less, the temperature can be automatically reduced to a selected minimal level to help conserve remaining battery life. In addition, the wireless heating control system application can utilize and communicate with other features or applications of the user's wireless control device or Smart Phone and provide automatic adjustments to the temperature of the connected heated garments or devices based on such communications. The system also can enable programming and setting of various default or user preferences using a memory function. Thus, different garments can be swapped between different users.

In one embodiment, the wireless heating control system application can link to and/or utilize gps location and/or a weather application on the user's Smart Phone to obtain feedback as to the ambient or surrounding environment temperature, or predicted weather changes or temperature information, and can be configured to enable adjustments to be made substantially automatically to the temperature level of the connected heated garments or devices. For example, as a user moves from an outdoor to an indoor environment, or as the surrounding temperature heats up, the wireless heating system control application can determine or be alerted to such an ambient temperature change by the user's Smart Phone, and in response, can communicate with the Bluetooth controller(s) of the heating system or systems of each of the paired/connected heated garments or devices with instructions to automatically adjust the amount of heat being applied thereto as needed to maintain the temperature of the heated garment or device at a desired or prescribed level. The application further will support its own weather feature that is able to display local weather conditions.

As further illustrated in FIGS. 10A-10B, the display or control screens 106A-106C for the wireless heating system control application 102 can be customizable so as to include tabs or indicators showing a status of each connected heating system, is engaged or on, or when they have been shut off; showing Bluetooth® status; providing an indicating of temperature auto-correction based on Smart Phone sensors and/or weather conditions; as well as different user selectable indications of temperature and/or charge level of connected items. As additionally shown in FIGS. 11A and 11B, other display or control screens can provide links to social media sites such as Facebook, and/or retail sites. For example, as indicated in FIG. 11A, if a heated garment or device is detected, but for which Bluetooth® connectivity has not been established, the user can be directed via link to an online store 103 where they can purchase the necessary application connection module or feature associated with the additional heated garment or device and/or can be provided with a catalog of items to purchase, such as next generation products, additional power battery packs, recommended items or links to product search features and/or nearby stores.

In addition, items that are not connected or being actively controlled can be grayed out or their controls deactivated so that no further adjustments can be made. In addition, the Smart Phone application can be further customized with different graphics or displays, and can be linked to social media such as Facebook or other social networks. Still further, for embodiments wherein a series of garments or devices are linked for control as a unit or one-piece suit, the system can be provided with an override feature to enable such unitary control.

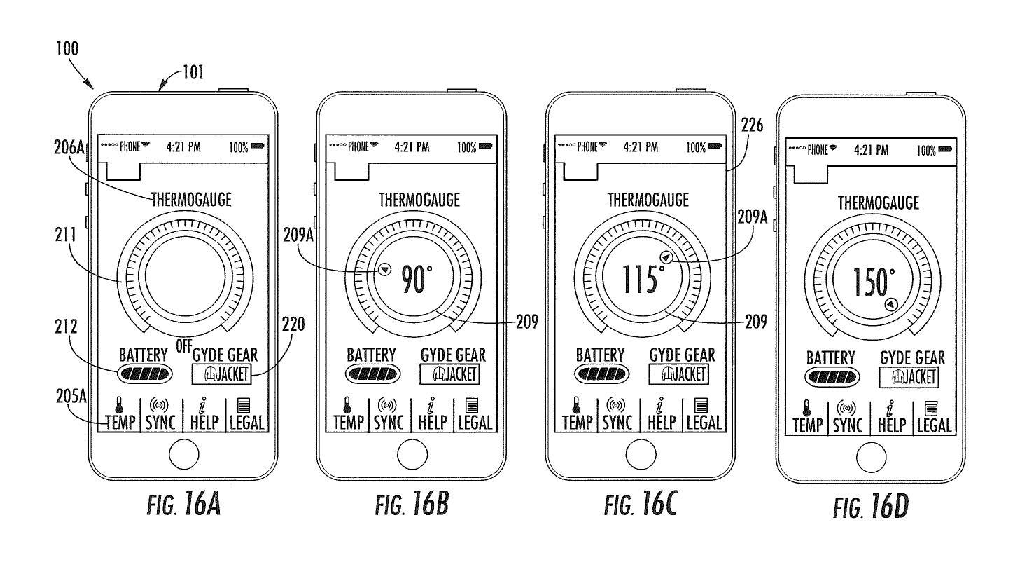

FIGS. 12A-18C illustrate further example display/control screens or pages 206A-206D of the wireless heating system control application 102 according to embodiments of the present invention. A user can toggle between these display/control screens or pages 206A-206D by touching or selecting indicators or icons 205A-205D. FIGS. 12A-12E and 16A-18C illustrate display or control screen 206A in which a user can selectively adjust the amount of heat applied by the heating system of each heated garment or device paired or connected to their Smart Phone or other wireless controller using a temperature gauge or dial 209. For example, a user can touch and slide a finger over the dial 209 to move or rotate the dial 209 clockwise or counterclockwise to adjust the temperature setting of a desired/selected garment or garments. Additionally, a scale or other visual indicator 210 can be disposed along and/or surround the dial 209, and the dial 209 can include a tab or indicator 209A to indicate the relative position of the dial 209 along the visual indicator 210. This visual indicator 210 may include a variably colored region, with color varying based on temperature, e.g., lighter colors indicating lower temperatures and darker colors indicating higher temperatures, and characters or symbols indicating an off position. Further, this visual indicator can include a plurality of notches or other symbols indicating the set or desired temperature (FIG. 16A-18C).

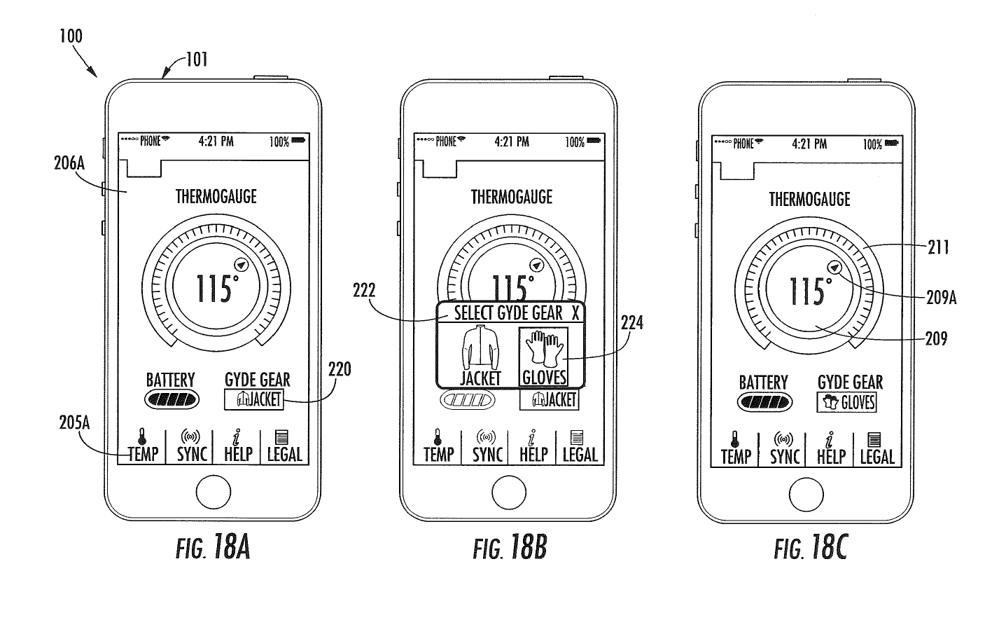

With this screen configuration or arrangement, a user can rotate or move the dial 209 between various positions along the visual indicator 210, indicated by location of tab 209A, to selectively adjust the temperature setting of a desired/selected garment or garments to a desired temperature based on the color of the visual indicator 210, e.g., a user can rotate the dial 209 such that the tab 209A is at positions of lighter color for lower desired temperatures and positions of darker color for higher desired temperatures (FIGS. 12A-12E). A user can further turn off a desired/selected garment or garments by rotating or positioning the dial 209 such that the tab 209A is at the off position. Additionally, the visual indicator may change colors as the dial 209 is rotated to indicate the set or desired temperature. For example, FIGS. 16A-18C illustrate that the visual indicator 210 can have a single or constant color when the dial indicator 209A is in the off position, and then, as the dial 209 is rotated, the visual indicator 210 or a color portion of the visual indicator can change colors, with rotation of the dial 209 to indicate the desired or set temperature. This color filled portion of the visual indicator 210 can be an area along the dial 209 defined between the position at which the dial indicator 209A is set and the off position or a position of minimum temperature (FIG. 18C). The color filled portion may also include a color gradient from lighter to darker with increasing temperature as noted above. The control screen 206A may further include temperature display 211 indicating the value of temperature of the desired/selected garment or garments. This display 211 can be superimposed on the dial 209, and the temperature value displayed by this display 211 may change as the dial 209 is rotated FIGS. 12B-12C, 16B-16D, and 17B-17D)

As also illustrated in FIGS. 12A-12C, screen 206A can further include a battery display 212 indicating the remaining power level of the desired/selected garment or garments. This battery display 212 may indicate the remaining power level graphically by displaying a variable number of bars and/or other visual indicators, which increase and decrease based on the remaining power level of the desired/selected garment or garments (FIGS. 12A-12C), though the battery display is not limited to such graphical representation and may indicate the remaining power level by a numerical value, percentage number, and/or other symbol. The control screen 206A may further include a heat lock icon or tab 213 selectable and/or slidable between on/off positions. For example, as illustrated in FIGS. 12C-12E, a user can touch and slide the heat lock tab 213 to an on position to engage or activate a heat lock function to set or lock the temperature of a desired/selected garment or garments. Further, upon selection of the heat lock icon or tab 213, an alert pop up window or screen 214 may pop up and be superimposed on the screen 206A before the heat lock function can be activated (FIG. 12D). This alert window 214 can include icons and/or indicators 215 selectable to activate the heat lock function ensuring a user did not inadvertently activate the heat lock function.

Moreover, the control screen 206A can further include a gear or garment selection icon or indicator 220, which may allow a user to toggle or change between control of different garments and/or groups of garments (FIGS. 16A-18C). FIGS. 18A-18C illustrate that this garment selection icon 220 may include characters, pictures, other visual indicators disposed thereon to indicate the selected garment, e.g., a jacket or a pair of gloves, and when a user touches or otherwise selects icon 220, a selection pop up window or screen 222 may be activated and superimposed on screen 206A. This selection screen 222 may include garment selection icons or indicators 224 selectable to allow a user to selectively choose between various garments. These garment selection icons 224 may further include characters, pictures or other visual indicators indicating the available or selectable garments, e.g., a jacket or gloves, and may include a further visual indicator, such as a box surrounding the above noted characters or pictures, to indicate the currently selected garment or garments. Further, after a user selects the desired garment or garments form the selection screen 222, dial 209 can then be used to control the selected garment or garments, and the visual indicator disposed on icon 220 can change and show the newly selected garment or garments (FIGS. 18A-18C).

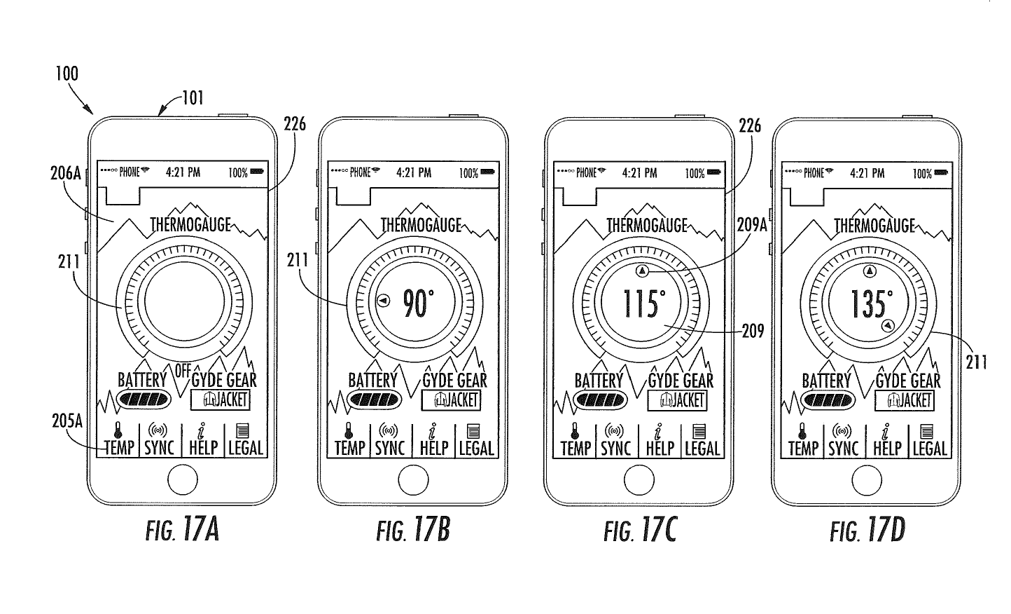

Additionally, a user can selectively control a desired/selected garment or garments based on the power received by such garment, e.g., 7 Volts or 12 Volts, and further, the images and/or functions displayed on the screen 206A can change based a selected power level. As illustrated in FIGS. 16A-17D, the screen 206 can include a header or other indicator 226 showing characters, pictures, or other symbols indicating the selected power level, e.g., 7 Volts or 12 Volts. Further, a background image shown on the screen 206A can change based on selection of different power levels. For example, if a 12 Volt power level is selected the background image may include a picture of a road or highway (FIGS. 16A-16D), and alternatively, if a 7 Volt power level is selected, the background image may include a picture of snow covered mountains or trees (FIGS. 17A-D). However, the background image is not so limited and may include any images, symbols, characters, and/or other suitable indicators to represent a desired/selected power level.

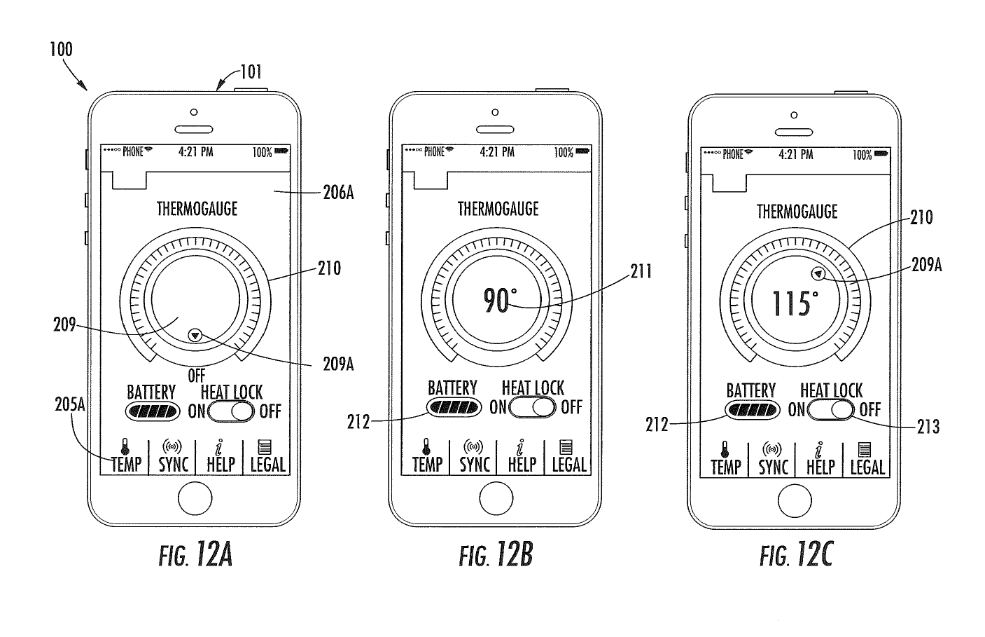

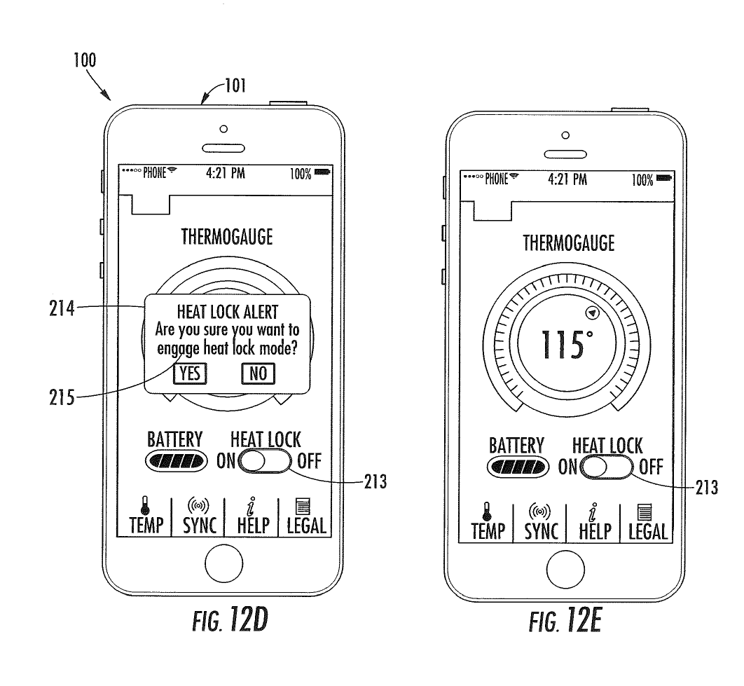

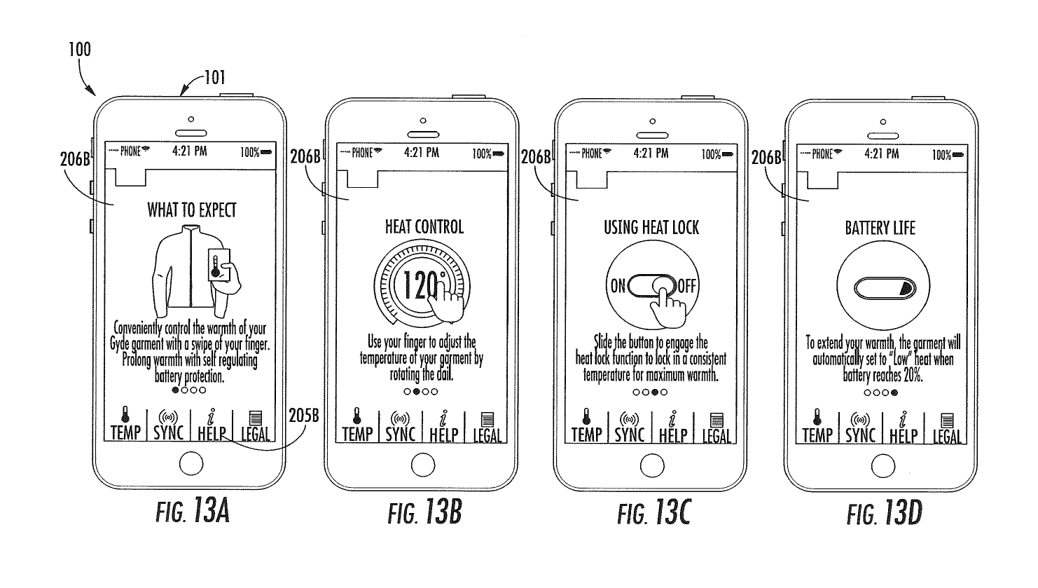

As shown in FIGS. 13A-13D, screens 206B can be displayed upon a user's selection of indicator or icon 205B. Screens 206B can include help screens or pages that may provide an general overview of the heating system (FIG. 13A), explanations on how to use the various features/functions of the heating system, such as the temperature dial 209 or the heat lock tab 213 (FIGS. 13B-13C), and explanations of the different features/functions of the heating system, such as the function in which a garment and/or garments is set to its lowest temperature setting when the power level reaches a predetermined threshold, e.g. 20 percent remaining (FIG. 13D). A user can further toggle between these different help screens via a swipe function, e.g. by touching and swiping a figure across the display, and/or by selecting various icons or indicators disposed on screen 206B.

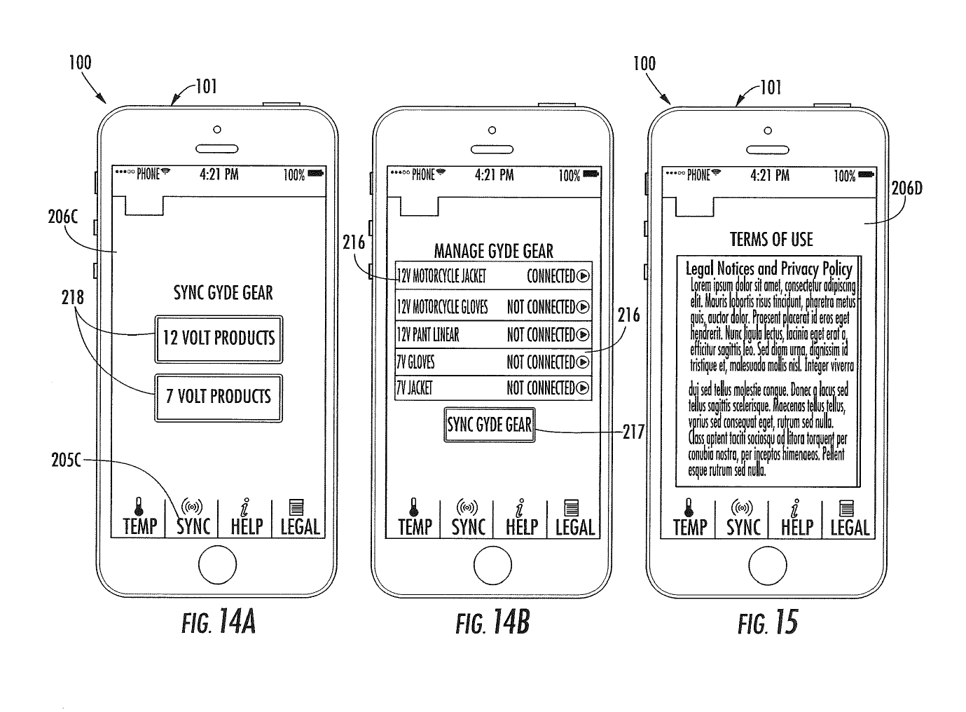

FIGS. 14A-14B illustrate screens 206C, which can be displayed by selection of indicator or icon 205C, including icons or indicators 216 that can indicate the different devices paired or connected to their Smart Phone or other wireless controller and that may be selectable to pair or connect and/or disconnect a desired/selected garment or garments. Screen 206C may further include a tab or icon 217 selectable to connect/disconnect a desired/selected garment or garments selected by icons 216 and/or to connect/disconnect all garments available to be paired or connected with the Smart Phone or other wireless controller. Screen 206B may further include icons or indicators 218 selectable to access different paired or connected garments based on the power level received by the garment or garments, e.g., 12 Volt garments or 7 Volt garments (FIG. 14A-14B). FIG. 15 further illustrates screen 206D displaying the terms of use and/or other legal notices and policies of the heating system, which is accessible to a user via selection of icon 205D.

The foregoing description generally illustrates and describes various embodiments of the present invention. It will, however, be understood by those skilled in the art that various changes and modifications can be made to the above-discussed construction of the present invention without departing from the spirit and scope of the invention as disclosed herein, and that it is intended that all matter contained in the above description or shown in the accompanying drawings shall be interpreted as being illustrative, and not to be taken in a limiting sense. Furthermore, the scope of the present disclosure shall be construed to cover various modifications, combinations, additions, alterations, etc., above and to the above-described embodiments, which shall be considered to be within the scope of the present invention. It therefore will be understood by those skilled in the art that while the present invention has been described above with reference to preferred embodiments, numerous variations, modifications, and additions can be made thereto without departing from the spirit and scope of the present invention as set forth in the following claims. Accordingly, various features and characteristics of the present invention as discussed herein may be selectively interchanged and applied to other illustrated and non-illustrated embodiments of the invention, and numerous variations, modifications, and additions further can be made thereto without departing from the spirit and scope of the present invention as set forth in the appended claims.

Additional objects of the general inventive concept include providing a method of heating and control of heat applied to an electrically-powered thermal-regulated apparel item. The method includes establishing an electrical power output from an electrical power source to an electrical power outlet connector in the controller as described above. In some embodiments, the method includes measuring the electrical resistance value of a thermistor or measuring a voltage level of a thermocouple and varying the electrical power output such that the resistance value or voltage level remains relatively constant with respect to the initially measured value/voltage level. For example, the thermistor or thermocouple can be embedded within the thermal-regulated apparel item and provide feedback for control as needed.

The exemplary embodiments of the present general inventive concept are implemented as a method of thermal regulation, an apparatus capable of thermal regulation, and a system capable of thermal regulation. While the present general inventive concept has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use; applications in contexts beyond thermal regulation of apparel also exist.

It is also to be understood that the claims to follow are or will be intended to cover all of the generic and specific features of the invention herein described, and all statements of the scope of the invention which, as a matter of language, might be said to fall therebetween. Hence, the proper scope of the present general inventive concept should be determined only by the broadest interpretation of such claims so as to encompass all such modifications as well as all relationships equivalent to those illustrated in the drawings and described in the specification.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

What is claimed is:

1. A thermally regulated apparel item, comprising:
an apparel item body formed from a textile material;
a heating control system for regulating application of heating to the apparel item body, comprising:
at least one heating element assembly located along the apparel item body and including an electrically powered heating element;
a controller coupled to the at least one heating element assembly, the controller having an electrical connection for receiving and transmitting electrical power from a power supply to the heating element of the at least one heating element assembly, and wherein the controller is configured to receive monitored feedback values indicative of a temperature of the garment or a thermal output level of the at least one heating element assembly and control instructions to control transmission of electrical power to the heating element of the at least one heating element assembly sufficient to maintain a user selected temperature or thermal output level for heating the garment; and
a wireless control device linked to the controller by a wireless connection, the wireless control device including a wireless control application configured to enable connection, monitoring, and control of a series of user selectable apparel items to the wireless control device, and a display having an identifier for each connected apparel item and a monitored temperature or thermal output value therefor, wherein the user is enabled to selectively control the temperature or thermal output of each of the series of apparel items connected to the wireless control device.

2. The thermally regulated garment of claim 1, wherein the electrically powered heating element comprises a conductive wire, filament, fiber or thread.

3. The thermally regulated garment of claim 1, wherein the heating element assembly further comprises a substrate, and wherein the heating element is applied along the substrate in a selected pattern.

4. The thermally regulated garment of claim 3, wherein a layer of a shielding and/or insulating material is attached to the substrate over the heating element.

5. The thermally regulated garment of claim 1, wherein the wireless control device comprises a smart phone.

6. The thermally regulated garment of claim 1, wherein the controller comprises two or more electrical power outlet connectors.

7. The thermally regulated garment of claim 6, wherein the first input control comprises two or more independently operating controls, and wherein said electrical power output at each of said two or more electrical power outlet connectors is independently controlled by one of said two or more first input controls.

8. The thermally regulated garment of claim 1, further comprising at least one sensor located along the apparel item body and connected to the controller for providing the monitored feedback values of temperature of the garment or thermal output to the controller.

9. The thermally regulated garment of claim 8, wherein at least one sensor comprises at least one thermistor or at least one thermocouple located along the heating element of the at least one heating element assembly and configured to measure an electrical resistance value or a voltage level along the heating element;
wherein the controller comprises an input control configured to establish an electrical power output level from the electrical power source to the heating element; and
wherein the wireless control device comprises a second input control linked to the controller and capable of being engaged and disengaged by the user, the second input control configured such that when engaged, the electrical resistance value of the thermistor or the voltage level of the thermocouple is measured and the electrical power output is varied by the controller such that the measured electrical resistance value of the thermistor or voltage level of the thermocouple substantially remains within a predetermined range for the measured electrical resistance value of the thermistor or the measured voltage level of the thermocouple approximately corresponding to the user selected temperature or thermal output level for the garment.

10. The thermally regulated garment of claim 1, further comprising a power source replaceably mountable within the garment body and including a Bluetooth® connector for wirelessly connecting the wireless control device.

11. A heating control system for controlling the temperature of a heated article, comprising:
at least one heating element incorporated into the heated article at a desired location;
a control module linked to the at least one heating element and to a power supply, for applying power to the at least one heating element as needed to generate heat and adjust the temperature of the heated article; and
a two-way wireless controller in communication with the control module and a wireless control device for transmitting a measured feedback value indicative of the temperature of the heated article to the wireless control device and receiving and communicating control instructions from the wireless control device to the control module;
wherein the wireless control device is remote from the control module and wirelessly connects thereto via the wireless controller, and wherein the wireless control device includes a wireless heating system control application comprising one or more control screens displaying a monitored temperature of the heated article wirelessly connected to the wireless control device, and controls enabling a user to selectively make adjustments to the monitored temperature of the heated article, which adjustments are communicated wirelessly to the control module.

12. The system of claim 11, wherein the wireless control device comprises a smart phone.

13. The system of claim 11, wherein the wireless heating control application includes a plurality of control screens displaying icons identifying each of a series of heated articles wirelessly connected to the wireless control device, and for selecting and controlling the monitored temperature of each heated article, wherein the control screens further comprise an indicator of a monitored a power level of the power supply, and links to additional applications and/or websites.

14. The system of claim 11, wherein the wireless heating control application is configured to monitor and control the temperature of at least 2 to 4 different heated articles.

15. The system of claim 11, further comprising at least one sensor integrated into the heated article and in communication with the control module to provide the measure feedback value indicative of the temperature of the heated article thereto.

16. The system of claim 15, wherein at least one sensor comprises at least one thermistor or at least one thermocouple located along the heating element of the at least one heating element assembly and configured to measure an electrical resistance value or a voltage level along the heating element; and
wherein the controller comprises an input control configured to establish an electrical power output level from the electrical power source to the heating element.

17. The system of claim 16, wherein the power supply comprises a Bluetooth® communications module integrated therewith.
